(19) United States
(12) Patent Application Publication
(10) Pub. No.: US 2024/0373049 A1
(43) Pub. Date: Nov. 7, 2024

(54) VIDEO DECODING ENGINE FOR PARALLEL DECODING OF MULTIPLE INPUT VIDEO STREAMS

(71) Applicant: QUALCOMM Incorporated, San Diego, CA (US)

(72) Inventors: Thomas Stockhammer, Bergen (DE); Imed Bouazizi, Frisco, TX (US)

(21) Appl. No.: 18/638,091

(22) Filed: Apr. 17, 2024

Related U.S. Application Data
(60) Provisional application No. 63/496,913, filed on Apr. 18, 2023.

(51) Int. Cl. H04N 19/436; H04N 19/136; H04N 19/70

(52) U.S. Cl. CPC H04N 19/436; H04N 19/136; H04N 19/70

(57) ABSTRACT

An example device for decoding media data includes a memory configured to store video data; and a processing system comprising one or more processors implemented in circuitry, the processing system being configured to: instantiate a first number of video decoder instances to be executed by the processing system; determine properties of a plurality of video media streams, the properties indicating that each of the plurality of video media streams is available for streaming selection; select a second number of input video media streams from the plurality of video media streams according to the determined properties of the second number of input video media streams; execute the video decoder instances to decode the second number of input video media streams to form the second number of decoded video media streams; and output data of the second number of decoded video media stream.

This application claims the benefit of U.S. Provisional Application No. 63/496,913, filed Apr. 18, 2023, the entire contents of which are hereby incorporated by reference.

### TECHNICAL FIELD

This disclosure relates to decoding of video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques related to decoding of multiple media streams for immersive media. This disclosure describes interfaces of a video decoding engine and operations related to elementary streams and metadata that can be performed by the video decoding engine. To support these operations, this disclosure also describes supplemental enhancement information (SEI) messages that may be used for various video codecs. In particular, this disclosure describes a decoding system in which multiple video decoding instances may be instantiated to support parallel decoding of multiple video bitstreams. The video bitstreams may be selectable according to decoding and rendering characteristics, which may be signaled using profile/tier/level and hypothetical reference decoder (HRD) parameters. Additionally, selected bitstreams for parallel decoding may jointly satisfy aggregate decoding and rendering characteristics. In this manner, video bitstreams may be aggregated for parallel decoding, which may improve decoding speed and thus reduce latency associated with displaying decoded video data.

In one example, a method of decoding media data includes: instantiating a first number of video decoder instances to be executed by video decoding hardware implemented in circuitry; determining properties of a plurality of video media streams, the properties indicating that each of the plurality of video media streams is available for streaming selection; selecting a second number of input video media streams from the plurality of video media streams according to the determined properties of the second number of input video media streams; decoding, by the video decoder instances, the second number of input video media streams to form the second number of decoded video media streams; and outputting data of the second number of decoded video media streams.

In another example, a device for decoding video data includes a memory configured to store video data; and a processing system comprising one or more processors implemented in circuitry, the processing system being configured to: instantiate a first number of video decoder instances to be executed by the processing system; determine properties of a plurality of video media streams, the properties indicating that each of the plurality of video media streams is available for streaming selection; select a second number of input video media streams from the plurality of video media streams according to the determined properties of the second number of input video media streams; execute the video decoder instances to decode the second number of input video media streams to form the second number of decoded video media streams; and output data of the second number of decoded video media stream.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network according to techniques of this disclosure.

FIG. 2 is a block diagram illustrating elements of an example video file.

FIG. 3 is a block diagram illustrating an example video decoding engine according to techniques of this disclosure.

FIG. 4 is a block diagram illustrating an example relationship between video decoder instances and a video decoder hardware engine according to techniques of this disclosure.

FIG. 5 is a conceptual diagram illustrating an example of instantiating multiple decoder instances of a video decoding engine using a video decoder interface according to techniques of this disclosure.

FIG. 6 is a block diagram illustrating an example video decoder interface systems decoder model according to techniques of this disclosure.

FIG. 7 is a conceptual diagram illustrating example input received by a filter and filtered output data according to techniques of this disclosure.

FIGS. 8A-8C are conceptual diagrams illustrating example input video with equal width received by an inserting function and combined output video according to techniques of this disclosure.

FIGS. 9A-9C are conceptual diagrams illustrating example input video with equal height received by an inserting function and combined output video according to techniques of this disclosure.

FIGS. 10A and 10B are conceptual diagrams illustrating examples of input video received by an appending function and corresponding output video data according to techniques of this disclosure.

FIGS. 11A and 11B are conceptual diagrams illustrating examples of input video received by a stacking function and corresponding output video data according to techniques of this disclosure.

FIG. 12 is a conceptual diagram illustrating example locations of boundaries of a layer of video data according to techniques of this disclosure.

FIG. 13 is a conceptual diagram illustrating an example of appending two layers of video data per a connection map according to techniques of this disclosure.

FIG. 14 is a conceptual diagram illustrating an example of appending three layers of video data per a connection map according to techniques of this disclosure.

FIG. 15 is a conceptual diagram illustrating an example of a video decoder engine employing application-based video decoder engine control to mosaic 2×2 video objects according to techniques of this disclosure.

FIG. 16 is a conceptual diagram illustrating an example of a video decoder engine executing four decoder engines to mosaic 2×2 video objects according to techniques of this disclosure.

FIG. 17 is a conceptual diagram illustrating an example of a video decoder executing one decoder engine to mosaic 2×2 video objects according to techniques of this disclosure.

FIG. 18 is a conceptual diagram illustrating an example implementation for formatting four media streams with different steps according to techniques of this disclosure.

FIG. 19 is a conceptual diagram illustrating an example implementation for formatting four media streams with two steps according to techniques of this disclosure.

FIG. 20 is a conceptual diagram illustrating an example of a video decoder engine using supplemental enhancement information (SEI)-based control information to mosaic 2×2 video objects according to techniques of this disclosure.

FIG. 21 is a conceptual diagram illustrating an example of connected components and buffer usage according to techniques of this disclosure.

FIG. 22 is a conceptual diagram illustrating example port configurations for various buffers according to techniques of this disclosure.

FIG. 23 is a conceptual diagram illustrating an example of media source extension (MSE) media interfaces according to techniques of this disclosure.

FIG. 24 is a block diagram illustrating an example video decoding hypothetical reference decoder.

FIG. 25 is a block diagram illustrating an example model of a video decoding system that may perform techniques of this disclosure to decode multiple video streams in parallel using multiple video decoding instances.

FIG. 26 is a block diagram illustrating another example model of a video decoding system that may perform techniques of this disclosure to decode multiple video streams in parallel using multiple video decoding instances.

FIG. 27 is a block diagram illustrating another example model of a video decoding system that may perform techniques of this disclosure to decode multiple video streams in parallel using multiple video decoding instances.

FIG. 28 is a flowchart illustrating an example method of decoding video data according to the techniques of this disclosure.

### DETAILED DESCRIPTION

In general, this disclosure describes a video decoding engine that may combine multiple input video streams to form a single output video stream. In some examples, the video decoding engine may instantiate multiple video decoding instances to decode multiple input video streams, then combine the decoded video streams. In some examples, the video decoding engine may use a single video decoding instance and use an input formatting unit to combine multiple input video streams, then use the single video decoding instance to decode the combined multiple input video streams. Various combinations of these examples are also possible, as discussed below.

In this manner, playback of media data from multiple input video streams may be achieved. Such playback may be synchronized between the various video streams, such that frames of the various input video streams are played back at appropriate playback times. These techniques may be used for two-dimensional video playback or other playback environments, such as extended reality (XR), augmented reality (AR), mixed reality (MR), or virtual reality (VR).

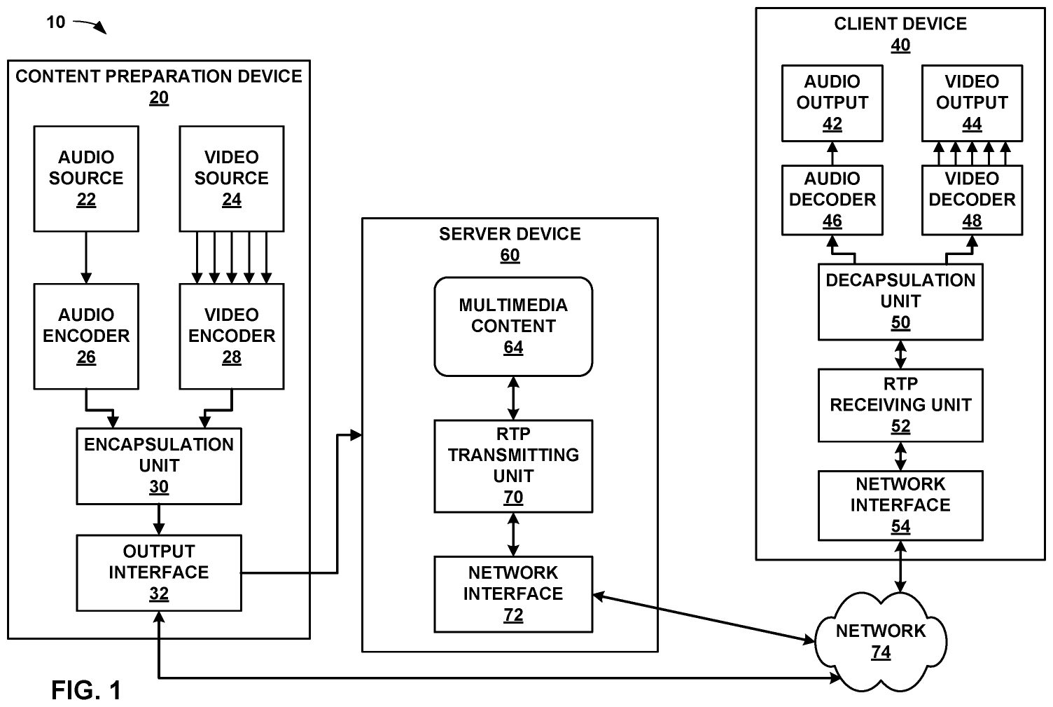

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is one example of a media stream. However, a media stream may include one or more elementary streams and/or other data, such that a media stream is not necessarily the same as a single elementary stream. A media stream may also contain metadata, such as non-VCL NAL units. An elementary stream of video data may include a series of pictures (also referred to as frames). This disclosure refers to a subframe as an independently decodable unit smaller than a frame to which post-decoding processing may have been applied by a video decoder. This disclosure refers to a video object as an independently decodable substream of a video elementary stream. This disclosure refers to a video object identifier as an integer or other value identifying a video object.

An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in multi-view video (MVC). These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement Uniform Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

According to the techniques of this disclosure, video decoder 48 may correspond to a video decoding engine. The video decoding engine, as explained in greater detail below, may include an input interface for receiving one or more media data streams and one or more metadata streams. The video decoding engine may include hardware components, such as memory and processing circuitry, that may instantiate one or more video decoder instances. Each video decoder instance may be exposed to an application layer as a respective video decoder with its own interface by which to send encoded video data to be decoded. Video decoder 48 may execute each of the various video decoder instances to decode the media data streams in parallel, and may format resulting output such that the output data is synchronized in time. In some examples, video decoder 48 may concatenate, append, stack, or otherwise combine or prune the video data for purposes of presentation by video output 44, as discussed in greater detail below.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC) Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

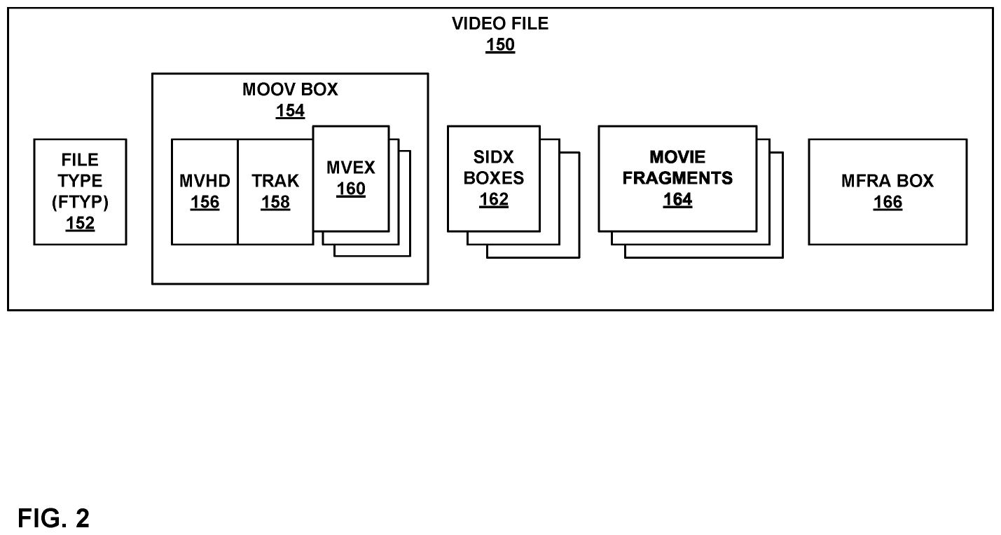

FIG. 2 is a block diagram illustrating elements of an example video file 150. As described above, video files in accordance with the ISO base media file format and extensions thereof store data in a series of objects, referred to as “boxes.” In the example of FIG. 2, video file 150 includes file type (FTYP) box 152, movie (MOOV) box 154, segment index (sidx) boxes 162, movie fragment (MOOF) boxes 164, and movie fragment random access (MFRA) box 166. Although FIG. 2 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

MOOV box 154, in the example of FIG. 2, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub) segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 2). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

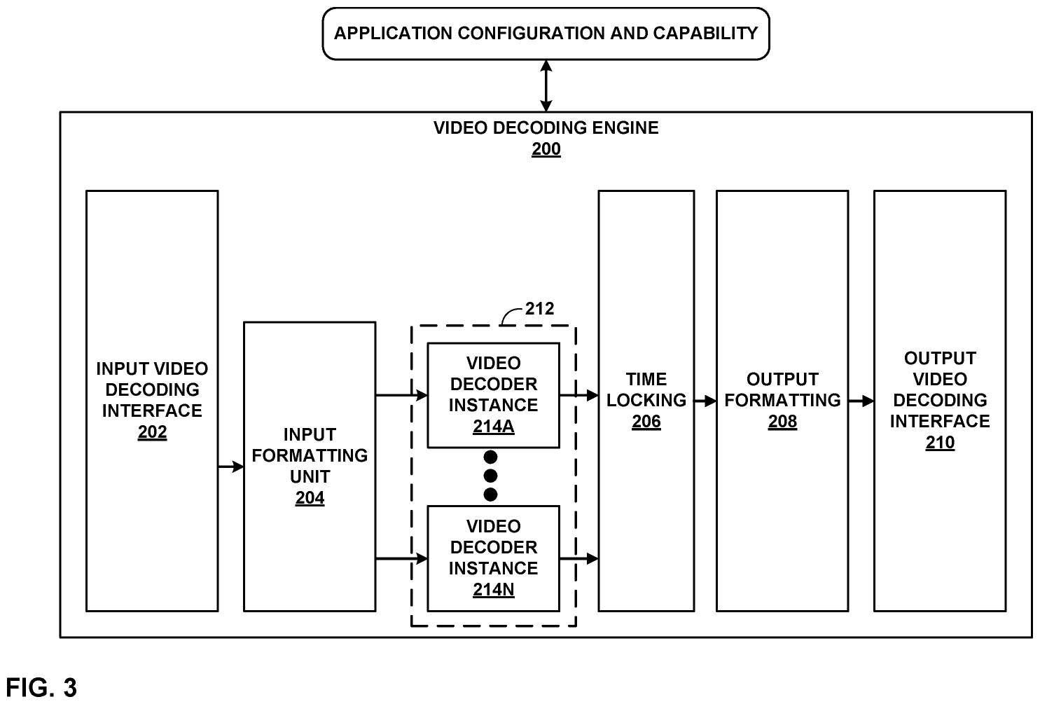

FIG. 3 is a block diagram illustrating an example video decoding engine 200 according to techniques of this disclosure. Video decoding engine 200 may correspond to video decoder 48 of FIG. 1. In this example, video decoding engine 200 includes input video decoding interface 202, input formatting unit 204, hardware video decoding engine 212, time locking unit 206, output formatting unit 208, and output video decoding interface 210. Hardware video decoding engine 212 may execute various video decoder instances 214A-214N (video decoding instances 214).

According to the techniques of this disclosure, video decoding engine (VDE) 200 enables decoding, synchronization and formatting of media streams. The media streams include one or more aggregated elementary streams or parts thereof. The media streams are fed through Input Video Decoding Interface (IVDI) 202 of VDE 200 and provided to the subsequent elements of the rendering pipeline via Output Video Decoding Interface (OVDI) 210 in their decoded form.

Between IVDI 202 and OVDI 210, input formatting unit 204 of VDE 200 extracts and merges independently decodable regions from a set of input media streams and generates a set of elementary streams fed to video decoder instances 214, which run inside VDE 200. VDE 200 can execute a merging operation or an extraction operation on the input media streams, such that the number of running video decoder instances 214 is different from the number of input media streams that are required by the application.

For example, VDE 200 might not be capable of decoding a single 4K input media stream with one decoder instance, but VDE 200 might be able to decode some of the independently decodable regions present in a 4K input video stream at a lower resolution. In this case, VDE 200 may verify the availability of sufficient resources to run video decoder instances 214 in parallel. In some examples, multiple elementary streams that are output by input formatting unit 204 may be fed to a single one of video decoder instances 214.

VDE 200 accepts media streams and metadata streams via IVDI 202. There is at least one media stream as input, but there is no constraint on the number of metadata streams with respect to the number of media streams being concurrently consumed by VDE 200. Thus, the input of VDE 200 includes N media streams, where N is at least 1, and M metadata streams, where M is zero or more.

VDE 200 outputs decoded video sequences and metadata streams via OVDI 210. There is at least one decoded video sequence as output, but there is no constraint on the number of metadata streams with respect to the number of decoded video sequences being concurrently output by VDE 200. These two output stream types may be provided in a form of multiplexed output buffers, including both decoded media data and its associated metadata. Thus, the output of VDE 200 includes Q decoded sequences, where Q is at least 1, and P metadata streams, where P is zero or more.

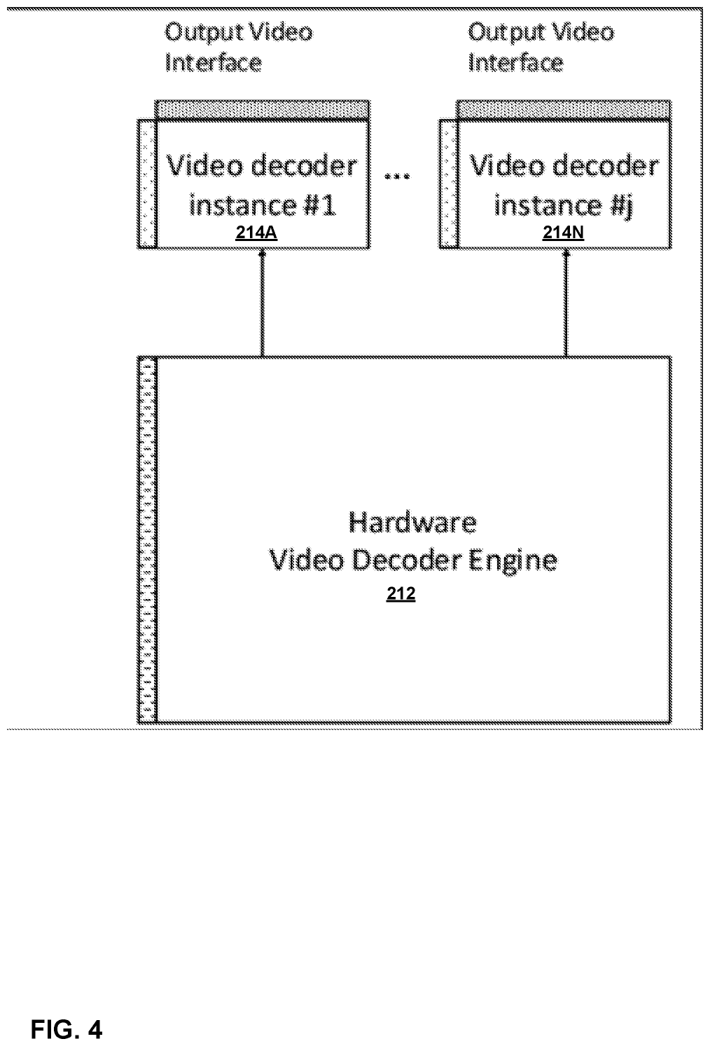

FIG. 4 is a block diagram illustrating an example relationship between video decoder instances 214 and hardware video decoding engine 212 according to techniques of this disclosure. In this example, one or more video decoder instances 214 are executed by the same hardware video decoding engine 212. Hardware video decoding engine 212 exposes each of video decoder instances 214 to the application layer as several decoder instances, each with their own input and output interfaces.

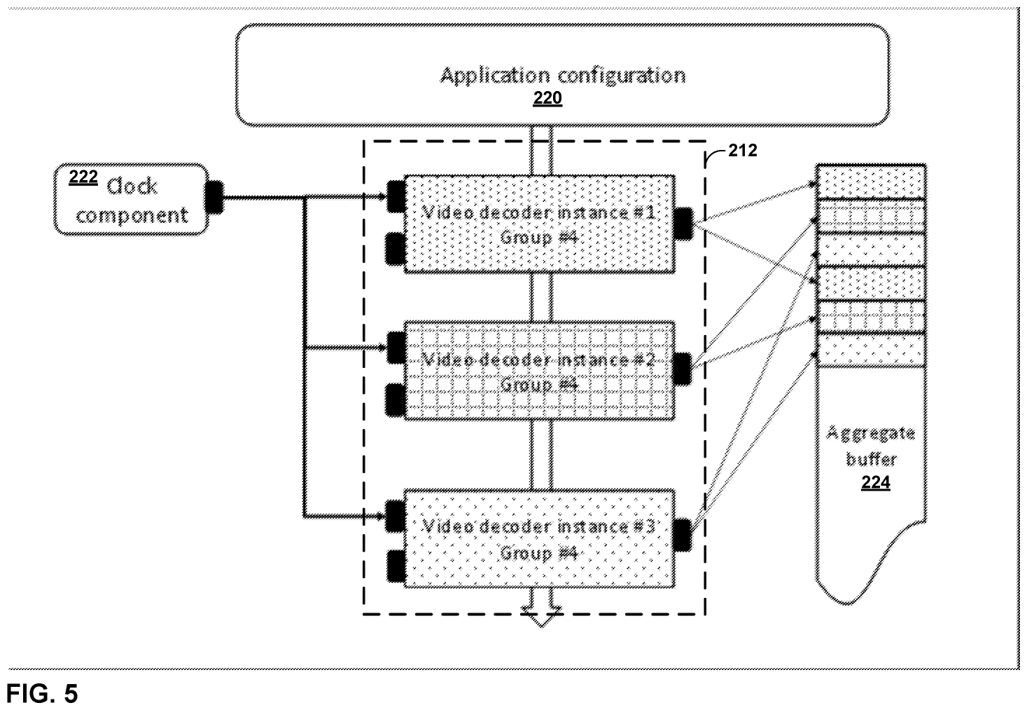

FIG. 5 is a conceptual diagram illustrating an example of instantiating multiple video decoder instances 214 of hardware video decoding engine 212 using a video decoder interface according to techniques of this disclosure. The example of FIG. 5 further depicts clock component 222, aggregate buffer 224, and application configuration information 220. Hardware video decoding engine 212 may receive application configuration information 220 from a multimedia application, such as a media player, extended reality (XR) player, or the like. A video decoding interface may include functions as defined using IDL syntax as specified in ISO/IEC 19516, “Information technology—Object management group—Interface definition language (IDL),” version 4.2.

In the example of FIG. 5, video decoder instances 214 may use some of the functionalities of a video decoding interface. Video decoder instances 214, in this example, have identifiers 1 to 3 and belong to a group with identifier 4. By this grouping mechanism, the three instances write decoded sequences into aggregate buffer 224, and the decoding operations across those instances are performed in a coordinated manner (with reference to a clock signal from clock component 222) such that no instance runs ahead or behind the others.

The IDL declarations of the queryCurrentAggregateCapabilities( ) function along with the AggregateCapabilities and PerformancePoint structures and the capabilities flags may be defined as follows:

```
const unsigned long CAP_INSTANCES_FLAG = 0x1;
  const unsigned long CAP_BUFFER_MEMORY_FLAG = 0x2;
  const unsigned long CAP_BITRATE_FLAG = 0x4;
  const unsigned long CAP_MAX_SAMPLES_SECOND_FLAG = 0x8;
  const unsigned long CAP_MAX_PERFORMANCE_POINT_FLAG = 0xA;
  struct PerformancePoint {
    float picture_rate;
    unsigned long width;
    unsigned long height;
    unsigned long bit_depth;
  };
  struct AggregateCapabilities {
    unsigned long flags;
    unsigned long max_instances;
    unsigned long buffer_memory;
    unsigned long bitrate;
    unsigned long max_samples_second;
    PerformancePoint max_performance_point;
  };
  AggregateCapabilities queryCurrentAggregateCapabilities (
    in string component_name,
    in unsigned long flags
),
```

The queryCurrentAggregateCapabilities( ) function can be used by the application to query the instantaneous aggregate capabilities of a decoder platform for a specific codec component. The capability flags can be set separately or in a single function call to query one or more parameters.

The component_name may provide the name of the component of the decoding platform for which the query applies. The name “All” may be used to indicate that the query is not for a particular component but is rather for all the components of the decoding platform. Components are hardware or software functionalities exposed by Video Decoding Engine 200, such as decoders.

CAP_INSTANCES_FLAG queries the max_instances parameter, which indicates the maximum number of decoder instances that can be instantiated at this moment for the provided decoder component.

CAP_BUFFER_MEMORY_FLAG queries the buffer_memory parameter, which indicates the instantaneous global maximum available buffer size in bytes that can be allocated independently of any components at this moment on the decoder platform for buffer exchange. The allocation of the memory can be done by the application or VDE 200 itself, depending on the VDE instantiation.

CAP_BITRATE_FLAG queries the bitrate parameter, which indicates the instantaneous maximum coded bitrate in bits per second that the queried component is able to process.

CAP_MAX_SAMPLES_SECOND_FLAG queries the max_samples_second parameter, which indicates the instantaneous maximum number of luma and chroma samples combined per second that the queried component is able to process.

CAP_MAX_PERFORMANCE_POINT_FLAG queries the max_performance_point parameter, which indicates the maximum performance point of a bitstream that can be decoded by the indicated component in a new instance of that decoder component.

A performance point may contain the following parameters:
picture_rate indicating the instantaneous picture rate of the maximum performance point in pictures per second.
height indicating the height in luma samples of the maximum performance point.
width indicating the width in luma samples of the maximum performance point.
bit_depth indicating the bit depth of the luma samples of the maximum performance point.

Each parameter of the max performance point does not necessarily represent the maximum in that dimension. The parameters may be the combination of all dimensions that constitutes the maximum performance point.

The IDL declarations of the getInstance( ) function and the associated ErrorAllocation exception may be defined as follows:

```
exception ErrorAllocation {
    string reason;
  };
  unsigned long getInstance(
    in string component_name,
    in unsigned long group_id // optional, default value = −1
  ) raises(ErrorAllocation);
```

The result of a successful call to the getInstance( )function call may provide an identifier of an instance and group_id that is assigned or created for this new instance, if a new instance was requested. The default behavior is that the decoder instance does not belong to any already established group but is assigned to a newly created group.

Several decoder instances belonging to the same group means that VDE 200 treats those instances collectively, such that the decoding statuses of those instances progress in synchrony and not in competition against each other. As a consequence, VDE 200 may ensure a synchronized output writing operation, possibly into aggregate buffer 224. There are no conditions for two video decoder instances to be in the same group.

The IDL declarations of the setConfig( ) function, the associated ErrorConfig exception, the ConfigDataParameters structure and the ConfigParameters enumeration may be defined as follows:

```
enum ConfigParameters {
    CONFIG_OUTPUT_BUFFER
  };
  struct ConfigDataParameters {
    SampleFormat sample_format;
    SampleType sample_type;
    unsigned long sample_stride;
    unsigned long line_stride;
    unsigned long buffer_offset;
  };
  exception ErrorConfig {
    string reason;
  };
  boolean setConfig (
    in unsigned long instance_id,
    in ConfigParameters config_parameters,
    in ConfigDataParameters config_data_parameters
  ) raises(ErrorConfig);
```

The setConfig( ) function may be called with the parameter CONFIG_OUTPUT_BUFFER to provide the format of the output buffer. The format of the buffer may contain the following parameters:
sample_format indicating the format of each sample, which can be a scalar, a 2D vector, a 3D vector, or a 4D vector.
sample_type indicating the type of each component of the sample.
sample_stride indicating the number of bytes between 2 consecutive samples of this output.
line_stride indicating the number of bytes between the first byte of one line and the first byte of the following line of this output.
buffer_offset indicating the offset into the output buffer, starting from which the output frame should be written.

The IDL declarations of the getParameter( ) and setParemeter( ) functions as well as the associated ErrorParameter exception and the ExtParameters enumeration may be defined as follows:

```
enum ExtParameters {
    PARAM_PARTIAL_OUTPUT,
    PARAM_SUBFRAME_OUTPUT,
    PARAM_METADATA_CALLBACK,
    PARAM_OUTPUT_CROP,
    PARAM_OUTPUT_CROP_WINDOW,
    PARAM_MAX_OFFTIME_JITTER
};
  struct CropWindow {
    unsigned long x;
    unsigned long y;
    unsigned long width;
    unsigned long height;
},
  exception ErrorParameter {
    string reason;
  };
  any getParameter (
    in unsigned long instance_id,
    in ExtParameters ext_parameters,
    out any parameter
  );
  boolean setParameter (
    in unsigned long instance_id,
    in ExtParameters ext_parameters,
    in any parameter
  ) raises(ErrorParameter);
```

The getParameter( ) and setParameter( ) functions can receive the extended parameters as discussed below.

PARAM_PARTIAL_OUTPUT may indicate whether the output of subframes is required, desired, or not allowed.

PARAM_SUBFRAME_OUTPUT may indicate one or more subframes to be output by the decoder.

PARAM_METADATA_CALLBACK may set a callback function for a specific metadata type. The list of supported metadata types may be codec-dependent and may be defined for each codec independently.

PARAM_OUTPUT_CROP may indicate that only part of the decoded frame is desired at the output. The decoder instance may use this information to intelligently reduce its decoding processing by discarding units that do not fall in the cropped output region whenever possible.

PARAM_OUTPUT_CROP_WINDOW may indicate the part of the decoded frame to be cropped and output.

PARAM_MAX_OFFTIME_JITTER may indicate the maximum amount of time in microseconds between consecutive executions of the decoder instance. This parameter may be relevant whenever the underlying hardware component is shared among multiple decoder instances, which requires context switching between the different decoder instances.

Vulkan® Video (VK) is an extension of the Vulkan API that defines functions exposed by Graphics Processing Units (GPU). This extension provides interfaces for an application to leverage hardware decoding and encoding capabilities present on GPUs. A VK Video Session includes a single decoding session on a single layer. As a result, a single VK Video Session corresponds to a single video decoder instance as depicted in FIG. 3. The mapping of VDI functions on VK is summarized in Table 1 below:

TABLE 1

| VDI functions | VK mapping |
|---|---|
| queryCurrent | New |
| AggregateCapabilities | vkGetPhysicalDeviceCurrent- |
| | VideoCapabilitiesMPEG( ) function |
| getInstance | Extending VkVideoSessionCreateInfoKHR with |
| (grouping) | a group identifier passed in the new structure |
| | VkVideoSessionCreateInfoGroupingMPEG. Call of |
| | existing vkCreateVideoSessionKHR( ). |
| setConfig (buffer | Mapping on existing VkVideoSessionCreateInfoKHR |
| configuration) | and VkVideoPictureResourceKHR structures. |
| getParameter and | New |
| setParameter | VkVideoSessionOutputParameterMPEG structure |

The VK Video API provides a function for querying capabilities for a single VK Video Profile which is called vkGetPhysicalDeviceVideoCapabilitiesKHR( ). Similar to this function, the VDI VK mapping defines the vkGetPhysicalDeviceCurrentVideoCapabilitiesMPEG( )function. In contrast to the vkGetPhysicalDeviceVideoCapabilitiesKHR( ) function, the vkGetPhysicalDeviceCurrentVideoCapabilitiesMPEG( )function allows to query the aggregates capabilities of the physical device. When it is called with a certain profile, the aggregated capabilities pertains to this given profile.

The vkGetPhysicalDeviceCurrentVideoCapabilitiesMPEG( ) function may be declared as follows:

| VkResult vkGetPhysicalDeviceCurrentVideoCapabilitiesMPEG( | |
|---|---|
| VkPhysicalDevice | physicalDevice, |
| VkVideoProfileKHR* | pVideoProfile, |

VkCurrentVideoCapabilitiesMPEG* pCapabilities);

In the declaration above, physicalDevice represents the physical device whose video decode or encode capabilities are to be queried; pVideoProfile is a pointer to a VkVideoProfileKHR structure with a chained codec-operation specific video profile structure; and pCapabilities is a pointer to a VkCurrentVideoCapabilitiesMPEG structure in which the capabilities are returned.

The VkCurrentVideoCapabilitiesMPEG structure holds the information returned by a call to the vkGetPhysicalDeviceCurrentVideoCapabilitiesMPEG( ) function defined above. The VkCurrentVideoCapabilitiesMPEG structure may be declared as follows:

| typedef struct VkCurrentVideoCapabilitiesMPEG { | |
|---|---|
| VkStructureType | sType; |
| void* | pNext; |
| uint32_t | maxInstances; |
| uint32_t | bufferMemory; |
| uint32_t | bitrate; |
| uint32_t | maxSamplesSecond; |
| VkPerformancePointMPEG* | maxPerformancePoint; |

} VkCurrentVideoCapabilitiesMPEG;

In the declaration above, sType is the type of this structure; pNext is NULL or a pointer to a structure extending this structure; pictureRate, height, width, and bitDepth may be the same as defined above.

The VkVideoSessionCreateInfoGroupingMPEG structure allows for attaching a group identifier to a video decoding instance created via the VK Video API. This structure extends the VkVideoSessionCreateInfoKHR structure defined in the VK Video API. The VkVideoSessionCreateInfoGroupingMPEG structure may be declared as follows:

| typedef struct VkVideoSessionCreateInfoGroupingMPEG { | |
|---|---|
| VkStructureType | sType; |
| const void* | pNext; |
| uint32_t | groupId; |

} VkVideoSessionCreateInfoGroupingMPEG;

In the declaration above, sType is the type of this structure; pNext is NULL or a pointer to a structure extending this structure; and groupId may be the same as defined above.

The VkVideoSessionOutputParameterMPEG structure contains parameters that configure the properties of the output of the VK Video Session. The VkVideoSessionOutputParameterMPEG may be declared as follows:

| typedef struct VkVideoSessionOutputParameterMPEG { | |
|---|---|
| VkStructureType | sType; |
| const void* | pNext; |
| VkFlag | partialOutput; |
| uint32_t* | subframeCount; |
| uint32_t* | pSubframeOutput; |
| VkFlag | outputCrop; |
| VkExtent2D* | pOutputCropWindow; |
| uint32_t | maxOfftimeJitter; |
| void* | pMetadataCallback; |

} VkVideoSessionOutputParameterMPEG;

In the declaration above, sType is the type of this structure; pNext is NULL or a pointer to a structure extending this structure; partialOutput, subframeCount, pSubframeOutput, outputCrop, pOutputCropWindow, maxOfftimeJitter and pMetadataCallback may have the same semantics as discussed above.

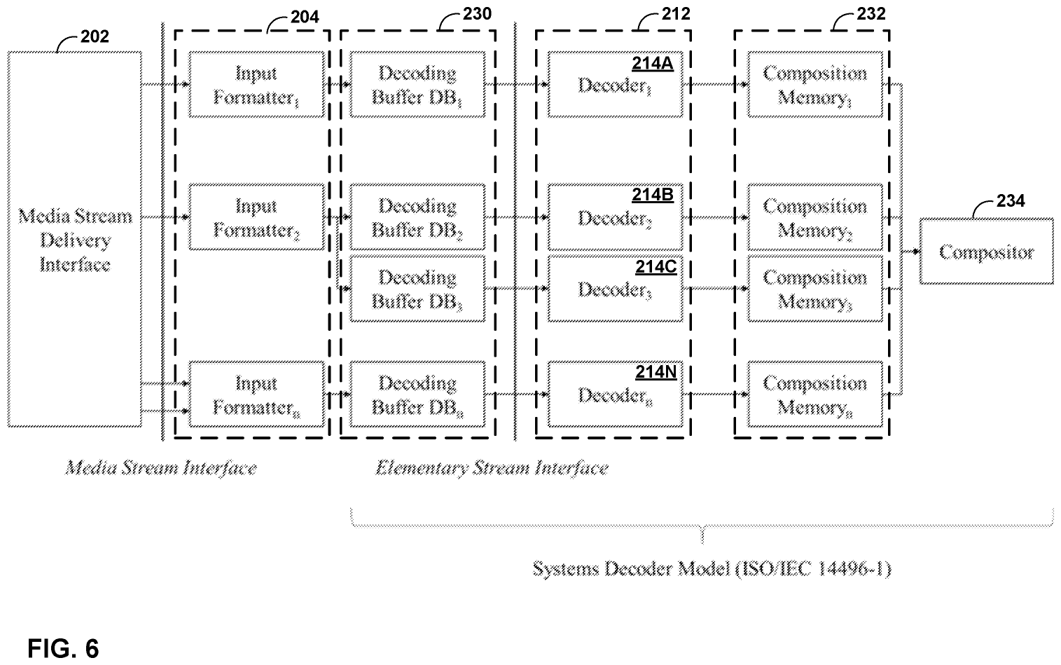

FIG. 6 is a block diagram illustrating an example video decoder interface (VDI) systems decoder model according to techniques of this disclosure. In this example, the VDI systems decoder model includes media stream delivery interface 202 (corresponding to IVDI 202), input formatting unit 204, decoder buffers 230, hardware video decoding engine 212 (which executes various instantiated video decoder instances 214A-214N), composition memory 232, and compositor unit 234.

VDI systems decoder model of FIG. 6 extends on the systems decoder model (SDM) defined in ISO/IEC 14496-1. Compared to the SDM, the VDI SDM introduces a new interface in addition to the elementary stream interface called media stream delivery interface 202. This interface is the input of input formatting unit 204, also called the input formatting function, which takes as input the so-called media streams. The output of input formatting unit 204 is one or more elementary streams that can be further passed on to video decoder instances 214.

Concepts for specification include formatting, timing, and buffering models.

Media stream delivery interface 202 is a concept that models the exchange of media stream data between the delivery interface and the input formatting function (input formatting unit 204).

The input formatter (input formatting unit 204) takes one or more media streams as input and generates one or more elementary streams as output. A single input formatter may be attached to several decoding buffers, such as the buffers of decoding buffer 230, when input formatting unit 204 produces individual elementary streams or multi-layer elementary streams.

Each of video decoder instances 214 may output decoded video data to respective portions of composition memory 232. Compositor unit 234 may retrieve decoded video data from the respective portions of composition memory 232 and compose an output video stream from the decoded video data.

Hardware video decoding engine 212 may spawn one or more video decoder instances 214. The number of instances running may be an optimization choice for the platform when taking into account available resources such as computational load, energy consumption, memory, etc. However, the number of input media streams fed through IVDI 202 is dictated by the application needs to properly render the media experience. Therefore, one or more input media streams may be fed to the same one of video decoding instances 214 via input formatting unit 204.

Input formatting unit 204 performs several operations on media streams and video objects. Input formatting unit 204 produces results in one or more elementary streams conforming to the profile, tier, level or any other performance constraints of corresponding video decoder instances 214 expected to consume the elementary streams, including buffer fullness of the hypothetical reference decoder model. Examples of such operations are defined below in an atomic way such that more complex operations can be achieved by combining them, as long as the final output includes valid elementary streams. The actual implementation of those combined operations is out-of-scope of this document and can be subject to optimization by the implementers as explained in more detail below.

A media stream may include one or more video objects, and a video object may be contained in one elementary stream. Each video object in an elementary stream provides information for enabling the defined operations, such as a means to determine the location and the dimension of the video object in the picture, the number of luma and chroma samples in the video object, the bit depth of the coded picture of the video object, and so on.

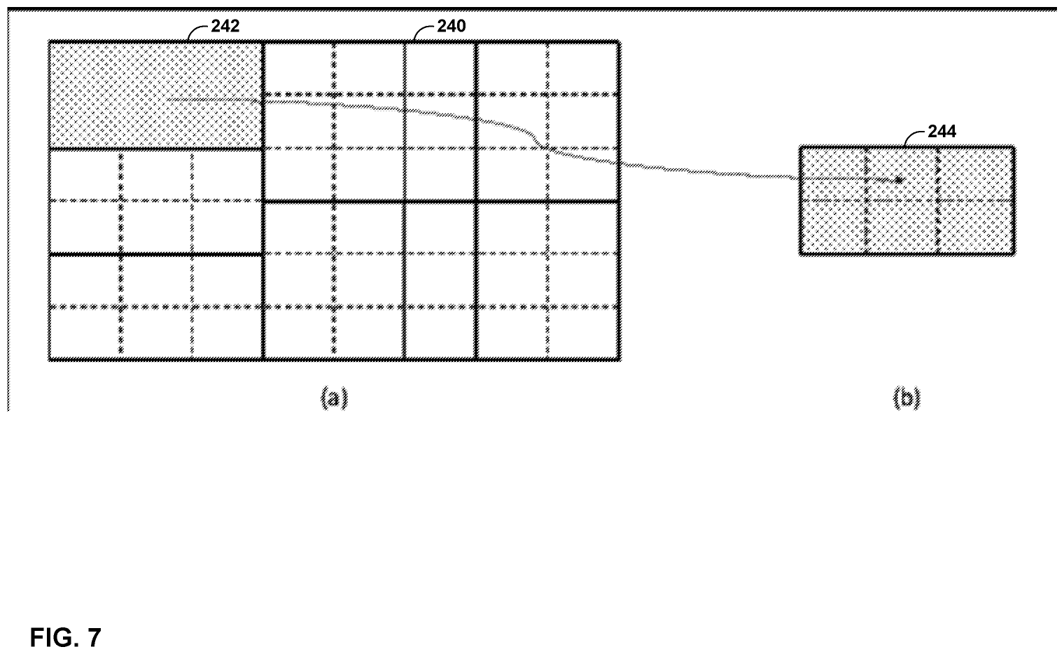

FIG. 7 is a conceptual diagram illustrating example input received by a filter and filtered output data according to techniques of this disclosure. Input formatting unit 204 executes the filtering function to extract one video object from an input media stream and returns an elementary stream as output which includes the selected video object.

Input formatting unit 204 may filter by video object identifier and/or by types of media data, such as a media stream type, an elementary stream type, an access unit type, a video object identifier type, and/or a video object sample type. A filter may be defined according to the form: “f: MDS×I→ES,” which indicates that input includes one media stream (MDS) with at least one video object and an identifier (I) of a selected video object to be extracted, and that output includes one elementary stream (ES) with one video object corresponding to the selected video object per the input. A signature for this filtering operation may be, “ElementaryStream output_stream filtering (MediaStream input_stream, VideoObjectIdentifier id).”

Thus, to perform filtering, for each i-th access unit in the input media stream, input formatting unit 204 may make a copy of the access unit. Then, input formatting unit 204 may list the video object samples present in the copied access unit. If a video object sample does not correspond to the video object identifier passed as input, the video object sample may be removed from the copied access unit. Lastly, input formatting unit 204 may append the copied access unit to the output elementary stream as a new access unit. That is, input formatting unit 204 may implement a filtering process based on a selected object identifier, that is the original access units are first copied and then removed from the unwanted objects. In this way, the operation does not need to create and initialize an empty access unit and the properties of the input access units are passed on to the access units of the output stream.

In case the video object is a slice, the filtering function extracts this slice in every coded picture from the input media stream and passes the extracted slice in the output elementary stream. In the example of FIG. 7, input formatting unit 204 receives a media data stream including pictures such as picture 240. Picture 240 includes slice 242. Input formatting unit 204 may extract slice 242 and output slice 242 in the form of output 244, as shown in FIG. 7. During this operation, the SPS, PPS and slice header may need to be updated as required by the corresponding video coding specification to correctly signal the size of the video of the output elementary stream, the information about the slices and tiles layout and the video object identifier, e.g., the slice address.

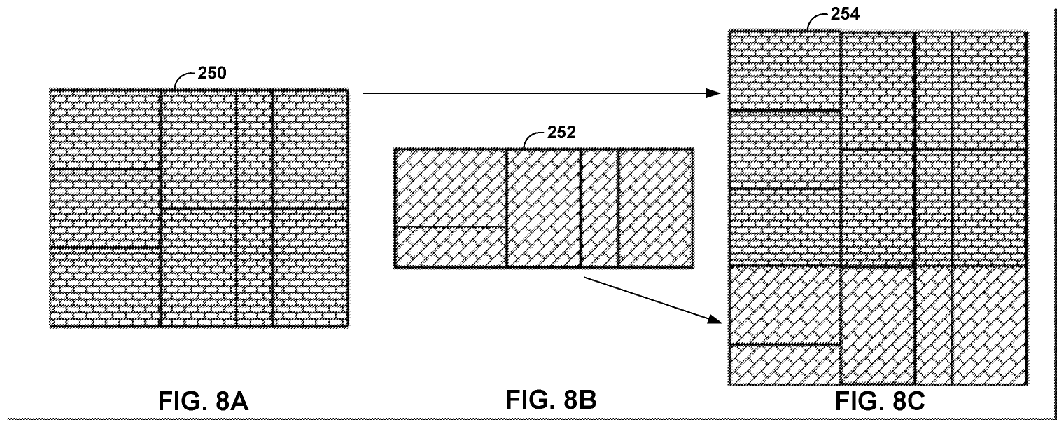

FIGS. 8A-8C are conceptual diagrams illustrating example input video with equal width received by an inserting function and combined output video according to techniques of this disclosure. Input formatting unit 204 may also perform an inserting operation. The inserting operation may be defined as “f: MDS×MDS→MDS.” The input includes two media streams containing at least one video object each, and the output may be one media stream with as many video objects as the sum of the video objects in both media streams. The signature for the inserting operation may be “MediaStream output_stream inserting(MediaStream input_stream_1, MediaStream input_stream_2).”

To perform inserting, for each i-th access unit in the first and second input media streams, input formatting unit 204 may make a copy of the i-th access unit of the second input media stream. Then, input formatting unit 204 may list the video object samples present in the i-th access unit from the first input media stream. Input formatting unit 204 may add each video object sample to the copied access unit. Lastly, input formatting unit 204 may append the copied access unit to the output media stream as a new access unit. Inserting may stop as soon as one of the two input media streams ends. The inserting operation may be defined as the insertion of video objects of the first input media stream into the second input media stream. In this way, the inserting operation does not need to create and initialize an empty access unit, but the properties of the access units of the second input media stream are passed on to the access units of the output media stream.

The inserting function takes the video objects from a first input media stream into a second input media stream and outputs the resulting output media stream, which includes the video objects from both first and second input media streams.

In case the video objects are slices, such as slice 250 of FIG. 8A and slice 252 of FIG. 8B, either the width or the height of the coded pictures of the input media streams are equal in order to maintain the rectangular shape of the video of the output media stream. In case the widths of the two input videos being equal, as shown in FIGS. 8A and 8B, the two videos are vertically stitched to form picture 254 of FIG. 8C. During this operation, the SPS, PPS and slice header may need to be updated to correctly signal the size of the video of the output media stream, the information about the slices and tiles layout and the video object identifiers, e.g., the slice addresses.

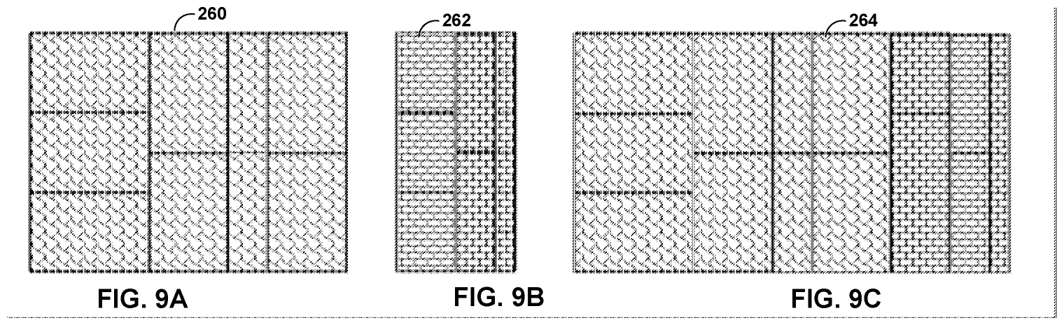

FIGS. 9A-9C are conceptual diagrams illustrating example input video with equal height received by an inserting function and combined output video according to techniques of this disclosure. If the heights of two videos are equal, as shown for slice 260 of FIG. 9A and slice 262 of FIG. 9B, then the two videos may be horizontally stitched to form picture 264 of FIG. 9C. During this operation as well, the SPS, PPS and slice header may need to be updated to correctly signal the size of the video of the output media stream, the information about the slices and tiles layout and the video object identifiers, e.g., the slice addresses.

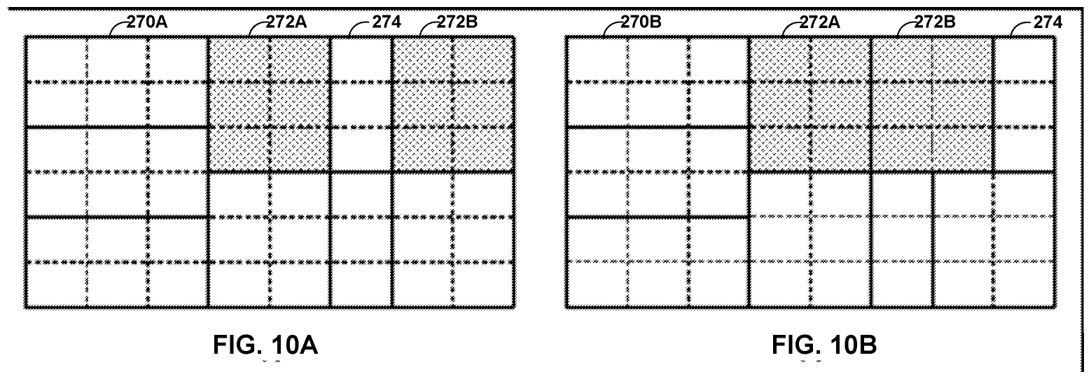

FIGS. 10A and 10B are conceptual diagrams illustrating examples of input video received by an appending function and corresponding output video data according to techniques of this disclosure. Input formatting unit 204 may perform an appending operation, which may be defined as “f: MDS→MDS.” The appending operation may take as input one media stream with at least two video objects, and form as output one media stream with two video objects that are left and right spatial neighbors. A signature for the appending operation may be, “MediaStream output_stream appending(MediaStream input_stream, VideoObjectIdentifier object_id_1, VideoObjectIdentifier object_id_2).

To perform the appending operation, input formatting unit 204 may, for each i-th access unit in the input media stream, make a copy of this i-th access unit. Then, input formatting unit 204 may set the position of the video object samples that belong to the video object identified by the second video object identifier to the right of the video object samples belonging to the object identified by the first video object identifier in this copied access unit. This positioning is done in such a way that the top boundaries of both video object samples are aligned. Lastly, input formatting unit 204 may append the copied access unit to the output media stream as a new access unit.

The appending function positions a first video object to the right of a second video object in the decoded pictures of the output media stream, which contains those two video objects. The output media stream is a media containing at least the first and second video objects positioned as side-by-side neighbors.

In case the video object is a slice, the slices of both video objects in the input media stream have the same height, as shown in the example of slices 272A, 272B of pictures 270A, 270B of FIGS. 10A and 10B. Slice 272B, on the right side, is moved next to slice 272A, on the left side, in picture 270B of the output media stream. Slice 274, which was in between slices 27A, 272B in picture 270A, is moved to the right of slices 272A, 272B, as shown in picture 270B of FIG. 10B. During this operation, the slice headers may need to be updated to correctly signal the changes of the video object identifiers, e.g., the slice addresses.

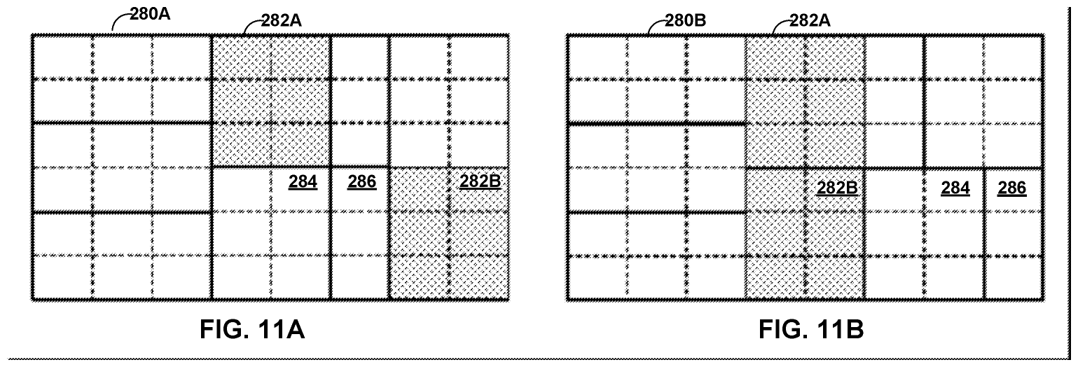

FIGS. 11A and 11B are conceptual diagrams illustrating examples of input video received by a stacking function and corresponding output video data according to techniques of this disclosure. Input formatting unit 204 may perform a stacking function, defined as “f: MDS→MDS.” The stacking function may take one media stream with at least two video objects as input, and produce one media stream with two video objects which are top and bottom spatial neighbors as output. A signature for the stacking function may be, “MediaStream output stream stacking (MediaStream input_stream, VideoObjectIdentifier object_id_1, VideoObjectIdentifier object_id_2).”

To perform the stacking function, input formatting unit 204 may, for each i-th access unit in the input media stream, make a copy of this i-th access unit. Then, input formatting unit 204 may set the position of the video object samples that belong to the video object identified by the second video object identifier below the video object samples belonging to the object identified by the first video object identifier in this copied access unit. This positioning is done in such a way that the left boundaries of both video object samples are aligned. Lastly, input formatting unit 204 may append the copied access unit to the output media stream as a new access unit.

The stacking function positions a first video object on top of a second video object in the decoded pictures of the media stream that contains those two video objects. The output media stream contains at least the first and second video objects positioned as top-and-bottom neighbors.

In case the video object is a slice, the slices of both video objects in the input media stream have the same width, as shown in the example of slices 282A, 282B of pictures 280A, 280B of FIGS. 11A and 11B. Slice 282B on the right side is moved to below slice 282A on the left side, as shown in picture 280B of FIG. 11B in the output media stream. Slices 284 and 286, below slice 282A in picture 280A of FIG. 11A, are moved to the right direction sequentially to the right side of slice 282B, as shown in picture 280B of FIG. 11B. During this operation, the slice headers may need to be updated to correctly signal the changes of the video object identifiers, e.g., the slice addresses.

The techniques of this disclosure may be used in conjunction with a video decoder instance conforming to ITU-T H.266/Versatile Video Coding (VVC). VVC is published under ISO/IEC 23090-3. Table 2 below provides bindings of VDI concepts with the concepts defined in VVC:

TABLE 2

| Concept | VVC definitions |
|---|---|
| ElementaryStream | bitstream |
| AccessUnit | access unit |
| VideoObjectIdentifier | nuh_layer_id |
| VideoObjectSample | picture unit |

A VVC elementary stream may be a compliant video stream according to ISO/IEC 23090-3, and the independent layer information SEI message may be defined per the definition below.

A VVC media stream used as an instantiation of the media stream may obey the following rules:
There shall be at least one VPS in the media stream and the parameters in each VPS shall be as follows:
   The flag vps_all_independent_layers_flag shall be set to 1.
The value of sh_picture_header_in_slice_header_flag shall be equal to 0 for all coded slices.
When present, the value of vps_num_output_layer_sets_minus2 shall be equal to the 0.

A VVC input media stream passed as an argument to the filtering function may comply with these rules in addition to those discussed above:
There shall be VCL NAL units with at least two different nuh_layer_id values.
One of the at least two different nuh_layer_id values shall be equal to the object identifier passed as argument of the filtering function.

A VVC elementary stream generated as output of the filtering function may comply with these rules in addition to the rules discussed above:
The number of access units in the output elementary stream shall be equal to the number of access units in the input elementary stream.
The number of VCL NAL units in the output elementary stream is equal to the number of VCL NAL units with nuh_layer_id equal to object identifier passed as argument of the function.
For each VCL NAL unit in the output elementary stream, there shall exist a VCL NAL unit in the input elementary stream that is bit exact identical.
All the NAL units in the output elementary stream shall have the same nuh_layer_id value and this nuh_layer_id value shall be equal to the object identifier passed as argument of the function.

Two VVC input media streams passed as arguments to the inserting function may comply with these rules in addition to the rules discussed above:
The nuh_layer_id value of each NAL unit in the first input media stream shall be different from any nuh_layer_id value present in the second input media stream.
If a SPS or PPS in the first input media stream has the same identifier than a SPS or PPS in the second input media stream, then those two SPSs or two PPSs shall have the same payload.

A VVC media stream generated as output of the inserting function may comply with these rules in addition to the rules discussed above:
The number of VCL NAL units in the output media stream is equal to the sum of the number of VCL NAL units in both input media streams.
For each VCL NAL unit in the output media stream, there shall exist a VCL NAL unit in of one of the two input media streams that is bit exact identical.

A VVC input media stream passed as argument to the appending function may comply with these rules in addition to the rules discussed above:
There shall be VCL NAL units with at least two different nuh_layer_id values.
Two of the at least two different nuh_layer_id values shall be equal to the two object identifiers passed as arguments of the appending function.

A VVC media stream generated as output of the appending function may comply with these rules in addition to the rules discussed above:
The number of VCL NAL units in the output media stream is equal to the number of VCL NAL units in the input media stream.
For each VCL NAL unit in the output media stream, there shall exist a VCL NAL unit in the input media stream that is bit exact identical.
There shall be an independent layer info SEI message whose nuh_layer_id is equal to the first video object identifier.
There shall be an independent layer info SEI message whose nuh_layer_id is equal to the second video object identifier.
The independent layer info SEI message whose nuh_layer_id is equal to the first video object identifier shall have its boundary_identifier_east value equal to the boundary_identifier_west value of the independent layer info SEI message whose nuh_layer_id is equal to the second video object identifier.

A VVC input media stream passed as an argument to the stacking function may comply with these rules in addition to the rules discussed above:
There shall be VCL NAL units with at least two different nuh_layer_id values.
Two of the at least two different nuh_layer_id values shall be equal to the two object identifiers passed as arguments of the appending function.

A VVC media stream generated as output of the stacking function may comply with these rules in addition to the rules discussed above:
The number of VCL NAL units in the output media stream is equal to the number of VCL NAL units in the input media stream.
For each VCL NAL unit in the output media stream, there shall exist a VCL NAL unit in the input media stream that is bit exact identical.
There shall be an independent layer info SEI message whose nuh_layer_id is equal to the first video object identifier.
There shall be an independent layer info SEI message whose nuh_layer_id is equal to the second video object identifier.
The Independent layer info SEI message whose nuh_layer_id is equal to the first video object identifier shall have its boundary_identifier_south value equal to the boundary_identifier_north value of the independent layer info SEI message whose nuh_layer_id is equal to the second video object identifier.

Additionally or alternatively, the techniques of this disclosure may be used with an Essential Video Coding (EVC) compliant video decoder instance. EVC is published under ISO/IEC 23094-1. Table 3 below provides an example of bindings of VDI concepts of this disclosure with the concepts defined in the EVC specification.

TABLE 3

| Concept | EVC definitions |
|---|---|
| Elementary Stream | bitstream |
| AccessUnit | access unit |
| VideoObjectIdentifier | the smallest value of the ID |
| | of the tiles in a slice |
| VideoObjectSample | slice |

An EVC media stream used as an instantiation of the media stream as discussed above may comply with the following rules:
There shall be at least two independently decodable slices whose smallest value of the ID of the tiles in each slice are different are defined.

An EVC input media stream passed as argument to the filtering function may comply with the following rules:
One of the smallest values of the ID of the tiles in each slice shall be equal to the object identifier passed as argument of the filtering function.

An EVC elementary stream generated as output of the filtering function may comply with the following rules:
The number of access units in the output elementary stream shall be equal to the number of access units in the input media stream.
The number of VCL NAL units in the output elementary stream is equal to the number of VCL NAL units with the smallest value of the ID of the tiles in the slice equal to object identifier passed as argument of the function.
For each VCL NAL unit in the output elementary stream, there shall exist a VCL NAL unit in the input media stream that is bit exact identical.
All the NAL units in the output elementary stream shall have the same smallest value of the ID of the tiles in the slice value and such value shall be equal to the object identifier passed as argument of the function.

Two EVC input media streams passed as arguments to the inserting function may comply with the following rules:
At least one of the values of pic_width_in_luma_samples or pic_height_in_luma_samples of the two media streams shall be identical.
If the values of pic_width_in_luma_samples are identical, then the values of num_tile_columns_minus1 shall be identical.
If the values of pic_height_in_luma_samples are identical, then the values of num_tiles_row_minus1 shall be identical.
If a SPS or PPS in the first input media stream has the same identifier than a SPS or PPS in the second input media stream, then those two SPSs or two PPSs shall have the same payload.

An EVC media stream generated as output of the inserting function may comply with the following rules:
The number of VCL NAL units in the output media stream is equal to the sum of the number of VCL NAL units in both input media streams.
For each VCL NAL unit in the output media stream, there shall exist a VCL NAL unit in of one of the two input media streams that is bit exact identical.

An EVC input media stream passed as an argument to the appending function may comply with the following rules:
At least two of the smallest values of the ID of the tiles in each slice shall be equal to the two object identifiers passed as arguments of the appending function.
The height of the slices, number of tile rows of the tiles included in the slices when the uniform tile spacing is used, whose smallest values of the ID of the tiles in each slice are identical as arguments of the appending function are identical.

An EVC media stream generated as output of the appending function may comply with the following rules:
The number of VCL NAL units in the output media stream is equal to the number of VCL NAL units in the input media stream.
For each VCL NAL unit in the output media stream, there shall exist a VCL NAL unit in the input media stream that is bit exact identical.

An EVC input media stream passed as an argument to the stacking function may comply with the following rules:
At least two of the smallest values of the ID of the tiles in each slice shall be equal to the two object identifiers passed as arguments of the appending function.
The width of the slices, number of tile columns of the tiles included in the slices when the uniform tile spacing is used, whose smallest values of the ID of the tiles in each slice are identical as arguments of the appending function are identical.

An EVC media stream generated as output of the stacking function may comply with the following rules:
The number of VCL NAL units in the output media stream is equal to the number of VCL NAL units in the input media stream.
For each VCL NAL unit in the output media stream, there shall exist a VCL NAL unit in the input media stream that is bit exact identical.

A control interface to the video decoding engine of this disclosure may be specified using the IDL syntax specified in ISO/IEC 29516. Additionally or alternatively, a control interface to the video decoding engine may be defined for OpenMax IL interface.

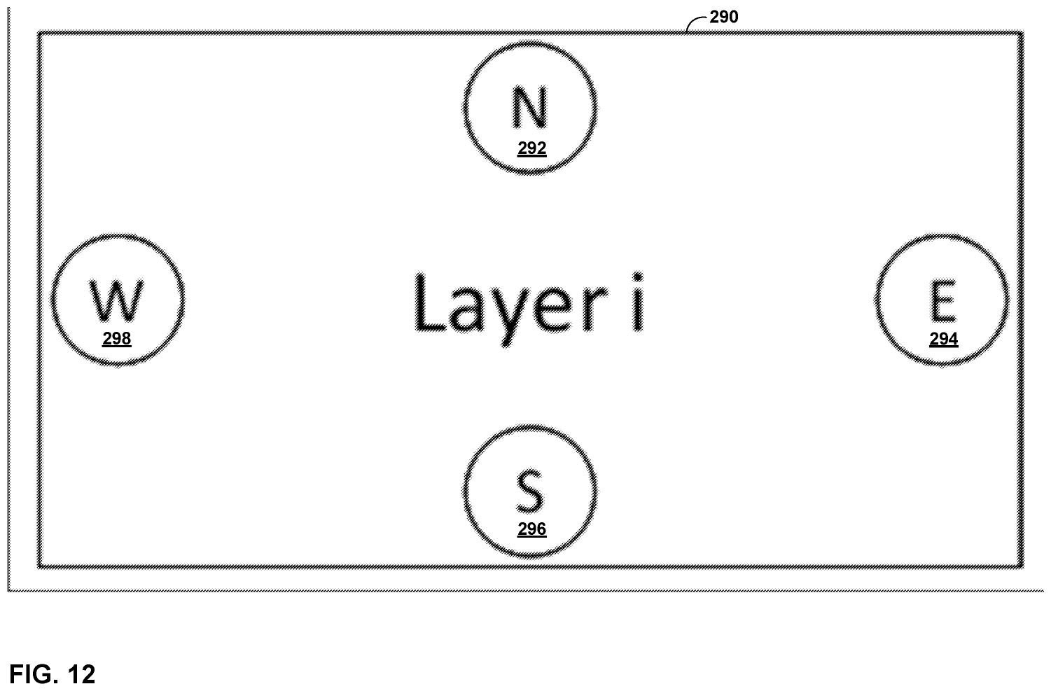

FIG. 12 is a conceptual diagram illustrating example locations of boundaries of a layer of video data according to techniques of this disclosure. In the example of FIG. 12, a supplemental enhancement information (SEI) message may specify, among other information, data representing, for a given layer i 290, whether layer i 290 couples to another layer at a northern boundary 292, an eastern boundary 294, a southern boundary 296, and/or a western boundary 298.

An example of a generic envelope for carrying SEI messages as defined in this document is defined below. Some of the VDI SEI messages may only apply to certain video coding specifications, e.g., HEVC, VVC, or EVC. The VDI SEI envelope may be registered as an SEI payload in ISO/IEC 23090-3.

Table 4 below defines example syntax of the VDI SEI envelope:

TABLE 4

| Syntax | Size | Type |
|---|---|---|
| vdi_sei_envelope( payloadSize ) { | | |
| vdi_sub_type | 8 | unsigned integer |
| if(vdi_sub_type == 0) | | |
| independent_layer_info(payloadSize − 1) | | |
| else | | |
| reserved_message(payloadSize − 1) | | |
| } | | |

Semantics for the vdi_sub_type may be as follows: “vdi_sub_type indicates the payload type carried in the VDI SEI envelope.”

Table 5 below defines example syntax of the independent layer information SEI message:

TABLE 5

| Syntax | Size | Type |
|---|---|---|
| independent_layer_info( payloadSize ) { | | |
| boundary_identifier_north_present_flag | 1 | bit |
| if(boundary_identifier_north_present_flag) | | |
| boundary_identifier_north | 16 | unsigned |
| | | integer |
| boundary_identifier_east_present_flag | 1 | bit |
| if(boundary_identifier_east_present_flag) | | |
| boundary_identifier_east | 16 | unsigned |
| | | integer |
| boundary_identifier_south_present_flag | 1 | bit |
| if(boundary_identifier_south_present_flag) | | |
| boundary_identifier_south | 16 | unsigned |
| | | integer |
| boundary_identifier_west_present_flag | 1 | bit |
| if(boundary_identifier_west_present_flag) | | |
| boundary_identifier_west | 16 | unsigned |
| | | integer |
| } | | |

Semantics for the independent layer information (info) SEI message semantics may be as defined below:
The independent layer info SEI message provides the spatial alignment of the different independent layers present in a bitstream by expressing the relative positioning between these layers using matching boundary identifiers. In a multi-layer bitstream, there shall be at most two occurrences of a given boundary identifier creating a pair of matching boundary identifier. In other words, a layer has at most one neighbor per boundary.
This SEI message may be extracted by the VDE and used for the output formatting function to correctly place the decoded pictures from each layer in the final output picture. In this case, the decoder instance may ignore this SEI message if present. Alternatively, the decoder instance may be capable of decoding a multi-layer bitstream as well as parsing the SEI message in which case no output formatting function is needed.
   boundary_identifier_north_present_flag, boundary_identifier_east_present_flag, boundary_identifier_south_present_flag and boundary_identifier_west_present_flag equal to 1 specify that the SEI message contains a boundary identifier, respectively, for the north, east, south, and/or west boundary.
   boundary_identifier_north, boundary_identifier_east, boundary_identifier_south and boundary_identifier_west specifiy the boundary identifier, respectively, at the north, east, south and west boundary of the decoded picture of the associated layer; the associated layer being the layer whose nuh_layer_id is equal to the nuh_layer_id of the SEI message. If not present, the boundary identifiers respectively at the north, east, south, and west boundary of the decoded picture of the associated layer are not defined.

As noted above, in the example of FIG. 12, layer i picture 290 represents a picture of layer i. An independent layer info SEI message may specify whether northern boundary 292 is to be attached to a boundary of another layer, whether eastern boundary 294 is to be attached to a boundary of another layer, whether southern boundary 296 is to be attached to a boundary of another layer, and/or whether western boundary 298 is to be attached to a boundary of another layer.

For two layers, the i-th and j-th layers, when the pair of the boundary_identifier_north value of the i-th layer and the boundary_identifier_south value of the j-th layer are equal, then the decoded picture of the i-th layer and the decoded picture of the j-th layer are to be placed adjacent in the composed output picture and share a common boundary at the north/south boundary. For i-th and j-th layers, when the pair of the boundary_identifier_east value of the i-th layer and the boundary_identifier_west value of the j-th layer are equal, then the decoded picture of the i-th layer and the decoded picture of the j-th layer are adjacent in the composed output picture and they share a common boundary at the east/west boundary.

Two decoded pictures adjacent by the north/south boundary may be aligned on their west boundary in the final output picture. Two decoded pictures adjacent by the east/west boundary may be aligned on their north boundary in the final output picture.

The independent layer info SEI messages present in the layers of an ouptut layer set (OLS) may collectively describe a 4-connected graph, and each layer of the OLS may be connected to the graph.

An example process for generating the final output picture is informative. The expected operations performed for generating the final output picture based on the decoded pictures of each layer from a selected OLS are described below:
For each Access Unit:
   If VPS present, parse VPS and store the list of layers in the bitstream.
   For each present PPS, determine the size in luma samples of the corresponding layer.
   For each present Independent layer info SEI message, parse the payload and store the boundary identifiers for the corresponding layer.
   If any of VPS, PPS or Independent layer info SEI message is present in the current Access Unit, calculate the horizontal, XPos, and vertical, YPos, positions of the top-left corner of each cropped decoded picture per layer in the final output picture. An example step sequence to calculate XPos and YPos is as follows:
      For each layer:
         Parse the list of cropped picture size and the boundary identifier.
         Identify the North, East, South, West neighbouring layers.
      Place each layer in a grid, with each grid cell corresponding to a North, East, South, West value for each layer that matches the corresponding neighboring value, respectively South, West, North, East.
      The value XPos for each layer corresponds to the sum of the widths of each layer in the same row of the grid, left of the current layer. The value YPos for each layer is corresponds to the sum of the heights of each layer in the same column of the grid, above the current layer.
   Initialize a picture buffer of size FinalWidth of width and FinalHeight of height for the final output picture where FinalWidth and FinalHeight are the width and height of the final output picture when all the layers are concatenated according to the defined graph.
   For each Picture Unit:
      Decode the coded picture.
   If pictures are ready for output:
      For each layer in selected OLS.
         Apply conformance window cropping on the decoded picture of the current layer.
         Retrieve XPos and YPos, the positions of the current layer in the final output picture in luma sample.
Copy cropped decoded picture in final output picture buffer at position (XPos, YPos) corresponding to the top-left corner of the cropped decoded picture.

If at the end of this process, the combination of all the decoded pictures does not provide decoded sample values for all the samples of the final output picture, the implementation may determine the values to be used for these unused samples.

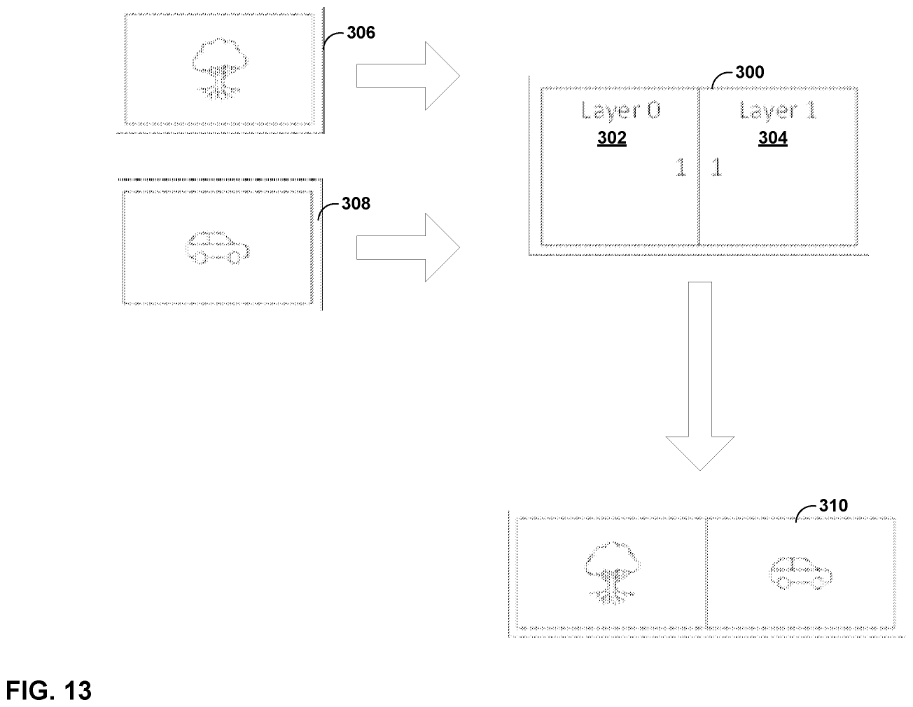

FIG. 13 is a conceptual diagram illustrating an example of appending two layers of video data per a connection map according to techniques of this disclosure. In particular, Layer 0 picture 306 and Layer 1 picture 308 may be combined according to connection map 300 to form output picture 310. As shown in this example, connection map 300 includes left picture 302, corresponding to Layer 0, and right picture 304, corresponding to Layer 1. Left picture 302 includes a value of “1” at the eastern boundary, and right picture 304 includes a value of “1” at the western boundary. Thus, VDE 200 may determine that Layer 0 pictures are to be appended, on the right side, to the left side of Layer 1 pictures.

Table 6 represents an example of properties of Layer 0 and Layer 1:

TABLE 6

| | | | Boundary identifiers |
|---|---|---|---|
| Sequence | Layer | Resolution | (N, E, S, W) |
| Left picture 302 | 0 | 416 × 240 | 0 1 0 0 |
| Right picture 304 | 1 | 416 × 240 | 0 0 0 1 |

Table 7 represents an example of properties of final output pictures:

TABLE 7
Resolution
832 × 240
Output sequence
Left picture 302 | Right picture 304

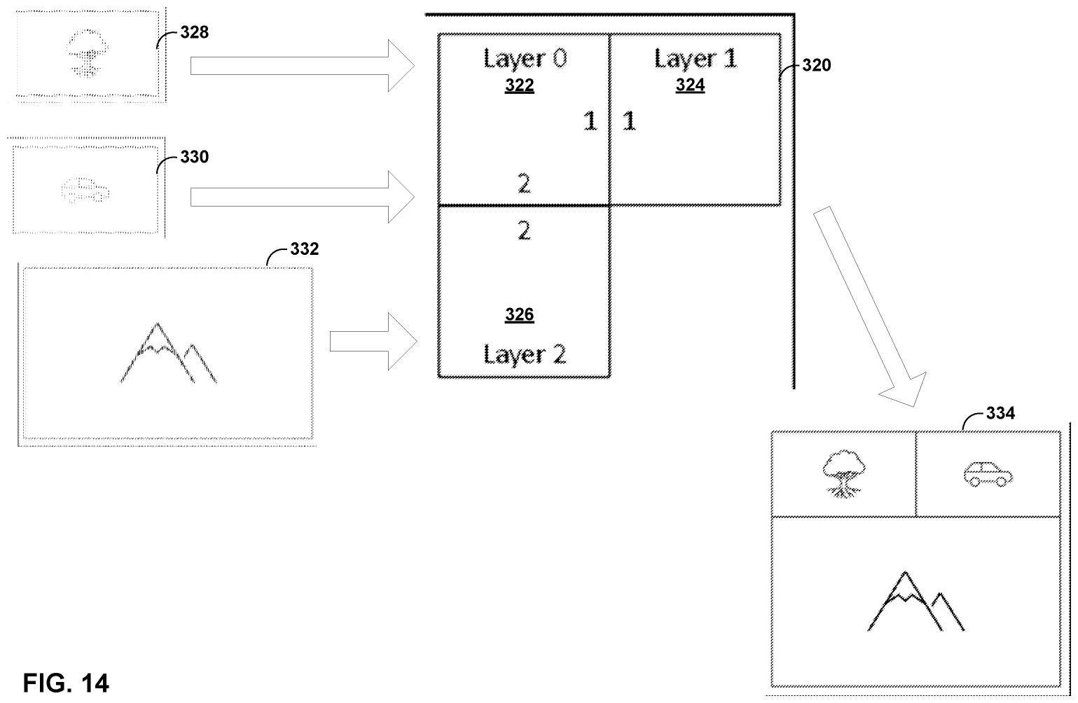

FIG. 14 is a conceptual diagram illustrating an example of appending three layers of video data per a connection map according to techniques of this disclosure. In this example, connection map 320 includes layer 0 picture 322, layer 1 picture 324, and layer 2 picture 326. Layer 0 picture 322 includes a value of “1” on an eastern border and a value of “2” on a southern border, while layer 1 picture 324 includes a value of “1” on a western border and layer 2 picture 326 includes a value of “2” on a northern border. Thus, for input picture 328 of layer 0, input picture 330 of layer 1, and input picture 332 of layer 2, per connection map 320, output picture 334 is formed by appending input picture 330 to a right side of input picture 328 and input picture 332 below input picture 328, such that input pictures 328 and 330 share a top boundary and input pictures 328 and 332 share a left boundary.

Table 8 represents an example of properties of Layers 0 to 2:

TABLE 8

| | | | Boundary |
|---|---|---|---|
| | | | identifiers |
| Sequence | Layer | Resolution | (N, E, S, W) |
| Input Picture 328 | 0 | 416 × 240 | 0 1 2 0 |
| Input Picture 330 | 1 | 416 × 240 | 0 0 0 1 |
| Input Picture 332 | 2 | 832 × 480 | 2 0 0 0 |

Based on this configuration, Table 9 presents the properties of the final output pictures:

TABLE 9
Resolution
832 × 720
Output sequence
$\frac{Input Picture 328 \vert Input Picture 330}{Input Picture 332}$

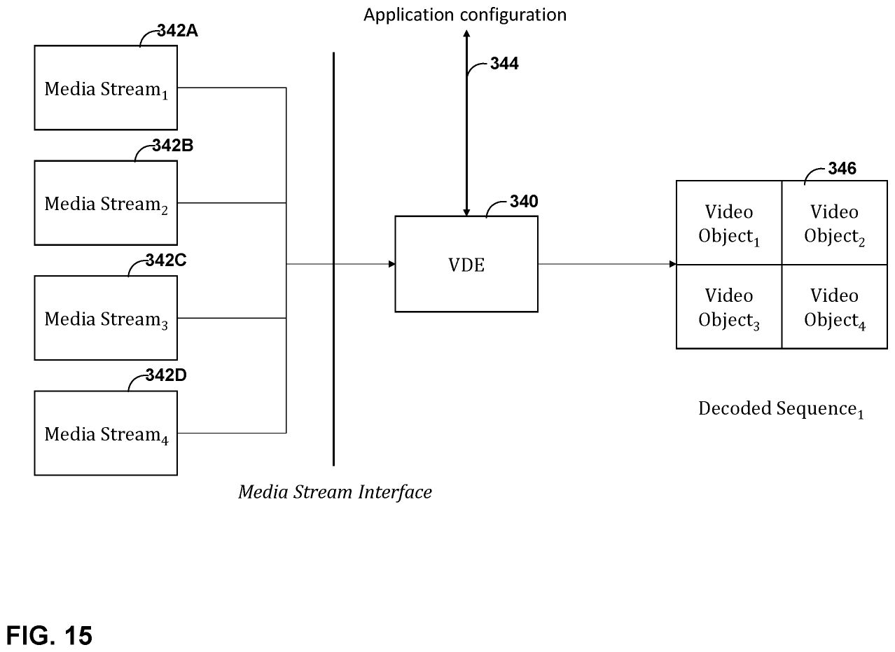

FIG. 15 is a conceptual diagram illustrating an example of a video decoding engine 340 employing application-based video decoding engine control to mosaic 2×2 video objects according to techniques of this disclosure. In particular, video decoding engine (VDE) 340 receives media data from media streams 342A-342D via a media stream interface. VDE 340 receives configuration data 344 from a media application. According to configuration data 344, VDE 340 extracts video objects from respective pictures of media streams 342A-342D to form output picture 346 in the form of a 2×2 mosaic.

The various operations as discussed above and the associated input and output constraints provide building blocks for various implementations of the input formatting function. The way a certain implementation converts the media streams to elementary streams based on the requested decoded sequences configuration is informative and left for optimization by the implementor as long as the output elementary streams meet the requirements of the elementary stream interface.

In the example of FIG. 15, the goal is to take four video objects as input in four different media streams 342A-342D and obtain as output of VDE 340 one decoded sequence containing the four decoded video objects arranged in a 2 by 2 grid in each picture of the decoded sequence. It is assumed that the media application is able to communicate to VDE 340 via an external communication channel to express how the media stream is to be arranged in the decoded sequences. For the purpose of the illustration, it is assumed that the four video objects have the same video resolution. FIG. 15 depicts the input situation at the media stream interface, input to VDE 340, and the intended situation at the output of VDE 340.

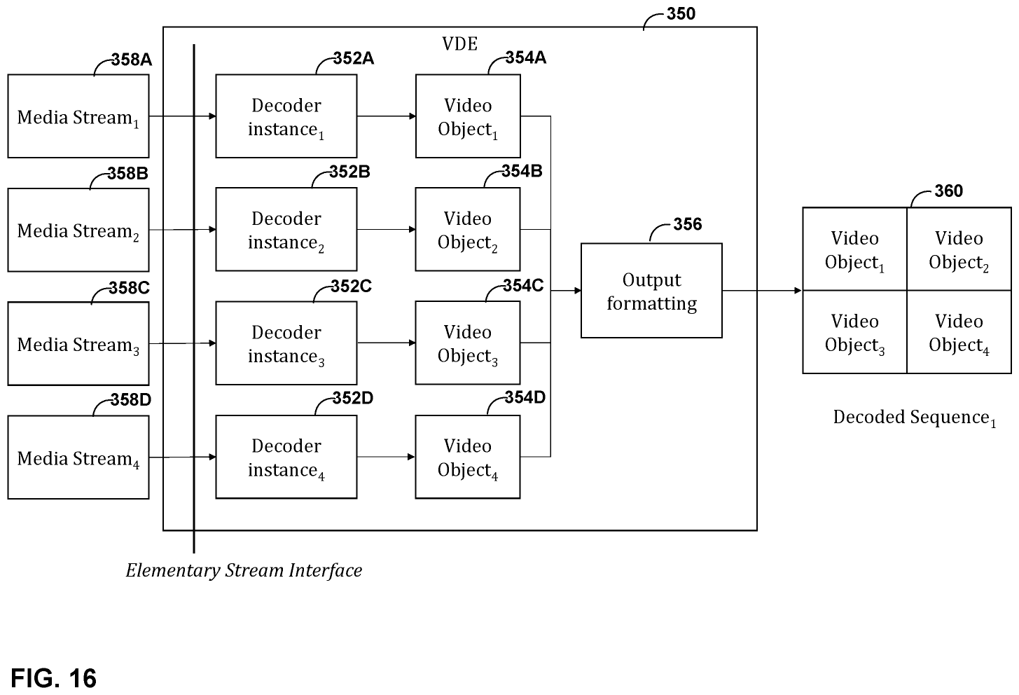

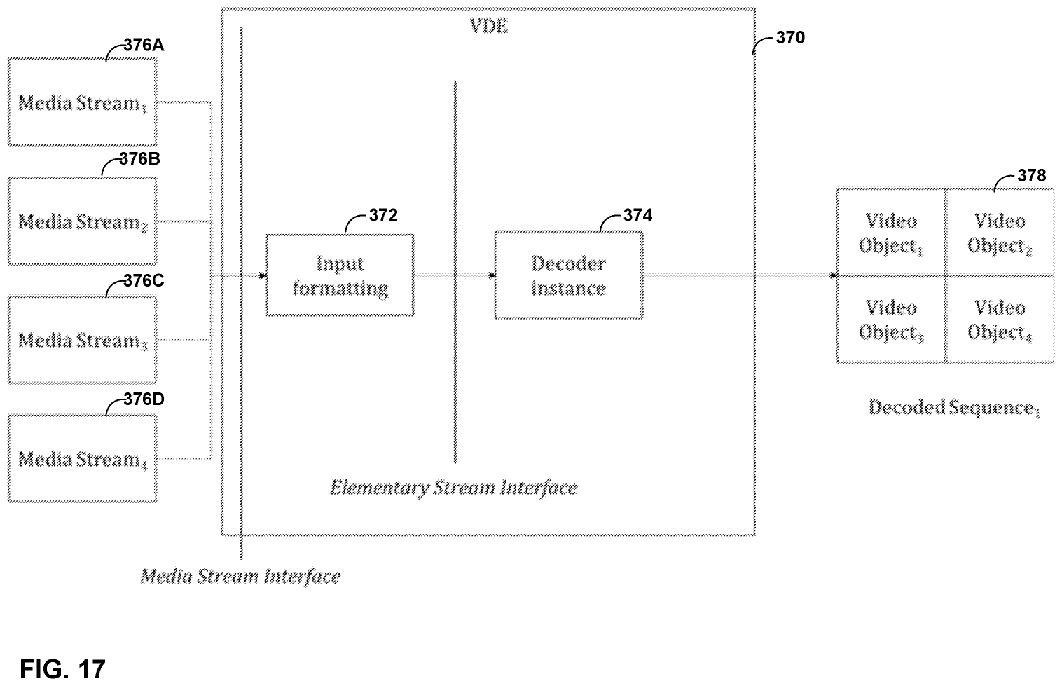

The output of the input formatting function may be an elementary stream interface. That is, the input formatting function (e.g., input formatting unit 204) may output data streams that are elementary streams. Whether it should be one elementary stream or multiple elementary streams is implementation and platform dependent. For this example, two examples are described. The first example is to have one video decoder instance per media stream (as in FIG. 16), the second example is to have one single decoder instance for the four media streams (as in FIG. 17).

FIG. 16 is a conceptual diagram illustrating an example of a video decoding engine executing four decoder engine instances to mosaic 2×2 video objects according to techniques of this disclosure. In this example, VDE 350 includes video decoder instances 352A-352D and output formatting unit 356. Each of video decoder instances 352A-352D receives as input video objects from respective media streams 358A-358D and decodes the video objects to form respective decoded video objects 354A-354D. Output formatting unit 356 assembles decoded video objects 354A-354D into output image 360, representing a 2×2 mosaic of decoded video objects 354A-354D.

In the case of one video decoder per media stream, as in the example of FIG. 16, the input formatting function is effectively an identity operation, i.e., each media stream is passed on to one decoder instance. That also means that each media stream is in this case also an elementary stream, which is allowed by the definition of a media stream. Then VDE 350 runs those four decoder instances in parallel, collects each output picture, and assembles the output pictures into a 2-by-2 arrangement for each set of temporally collocated decoded pictures as shown FIG. 16.

FIG. 17 is a conceptual diagram illustrating an example of a video decoder executing one decoder engine instance to mosaic 2×2 video objects according to techniques of this disclosure. In this example, VDE 370 includes input formatting unit 372 and a single decoder instance 374. Input formatting unit 372 receives video objects from each of media streams 376A-376D and assembles the received video objects into a single input encoded frame using the various operations discussed above. This input encoded frame forms part of an elementary stream. Decoder instance 374 then decodes the encoded frame to form decoded picture 378, including video objects from each of media streams 376A-376D.

In the case of one video decoder for the four media streams, input formatting unit 372 creates a single elementary stream out of the four input media streams. After that, VDE 370 runs a conventional pipeline with a single decoder instance 374, and outputs the decoded picture 378 from the decoder instance without the need of further processing before being output by VDE 370.

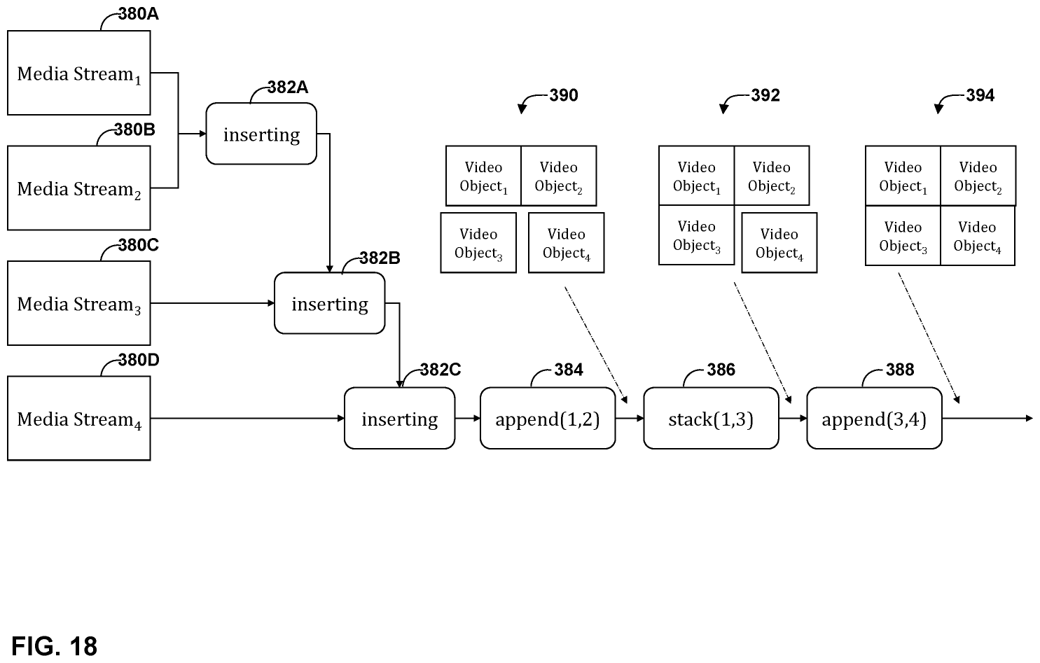

FIG. 18 is a conceptual diagram illustrating an example implementation for formatting four media streams with different steps according to techniques of this disclosure. Regarding the actual implementation of the input formatting function for the example as discussed with respect to FIG. 17, there can be different approaches. FIG. 18 depicts one such example. In this example, the operations include insert, append, and stack operations to form the input video data. In this example, the implementation would cascade those operations in a graph as depicted in FIG. 18.

In particular, in this example, media streams 380A-380D provide video objects. An input formatting unit, such as input formatting unit 372, may perform inserting operation 382A on video objects from media streams 380A and 380B to form a first intermediate video object. Input formatting unit 372 may then perform inserting operation 382B on the first intermediate video object and a video object from media stream 380C to form a second intermediate video object. Input formatting unit 372 may then perform inserting operation 382C to on the second intermediate video object and a video object from media stream 380D to form a third intermediate video object.

The third intermediate video object would contain each of the various video objects, but not necessarily correctly assembled. Thus, input formatting unit 372 may first perform an append (1, 2) operation 384 to appropriately combine the video objects from media streams 380A and 380B, as shown in intermediate video object 390. Input formatting unit 372 may then perform a stack (1, 3) operation 386 to appropriately add the video object from media stream 380C, as shown in intermediate video object 392. Finally, input formatting unit 372 may perform append (3, 4) operation 388 to appropriately add the video object from media stream 380D, as shown in final video object 394.

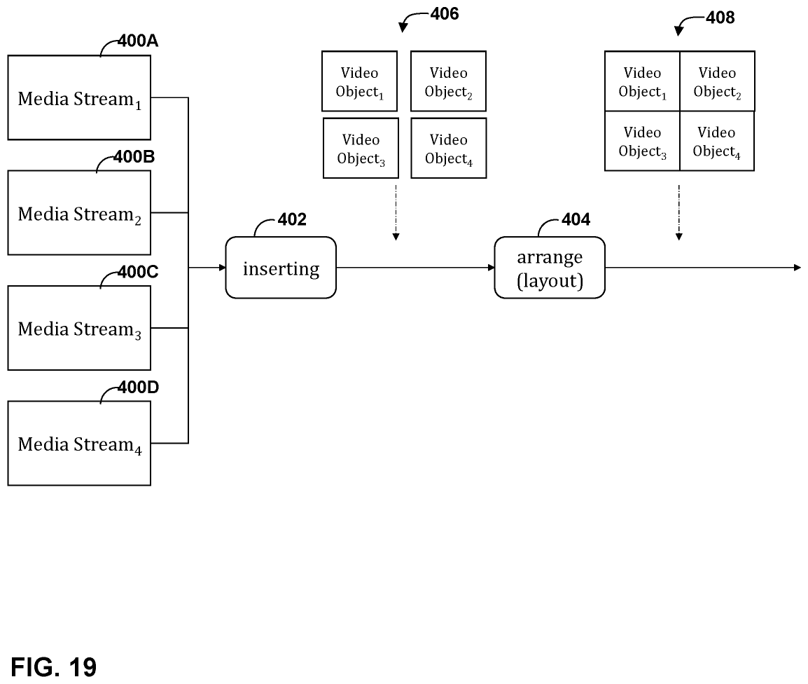

FIG. 19 is a conceptual diagram illustrating an example implementation for formatting four media streams with two steps according to techniques of this disclosure. FIG. 19 depicts an alternative example to that shown in FIG. 18 to achieve similar results for the example of FIG. 17. In this example, an implementation may support an inserting function that receives several media streams as input and generates an elementary stream in a single function call. In addition, this implementation may also have a proprietary function, called “arrange,” so that the arrangement can be established in the elementary stream in one function call.

In particular, in the example of FIG. 19, input formatting unit 372 may receive video objects from each of media streams 400A-400D. Input formatting unit 372 may initially execute inserting operation 402 to insert the video objects into combined video object 406. Input formatting unit 372 may then execute arrange operation 404 to appropriately arrange the video objects, forming final video object 408.

In still another example, there may be only one function combining the media streams, arranging the video objects from the media streams, and outputting the arranged video objects as part of an elementary stream.

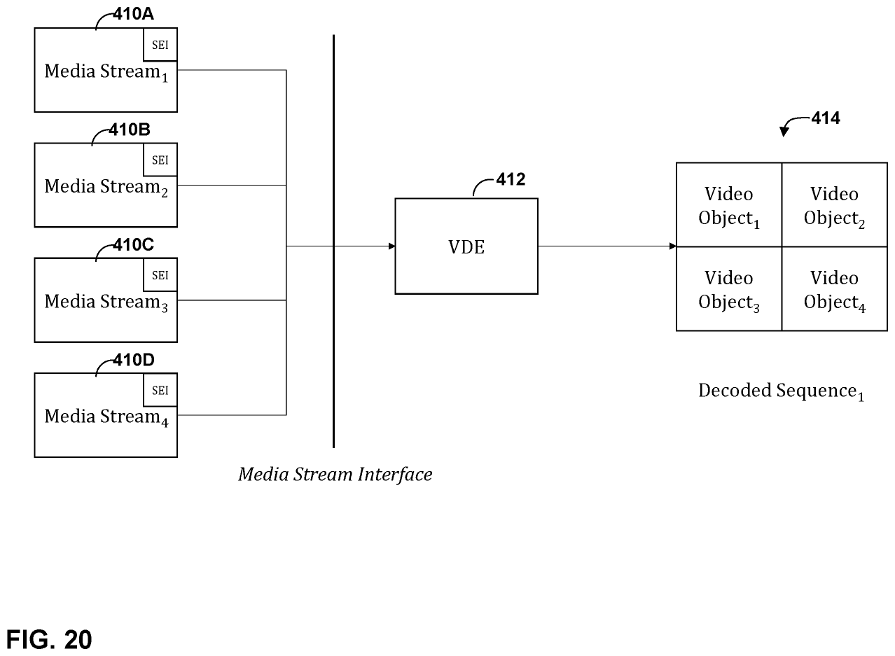

FIG. 20 is a conceptual diagram illustrating an example of a video decoding engine using supplemental enhancement information (SEI)-based control information to mosaic 2×2 video objects according to techniques of this disclosure. In this example, VDE 412 receives video objects from media streams 410A-410D, which also include SEI messages. The SEI messages may include data representing, e.g., a number of video encoding instances to be instantiated and/or arrangement information indicating how to arrange the video objects from media streams 410A-410D. VDE 412 may decode the video objects and arrange the video objects according to the SEI messages to ultimately form output picture 414.

This example shows the same intended output result as discussed above. The difference in FIG. 20 is that there is no communication assumed between VDE 412 and the media application as to how to arrange the video objects together in the decoded sequence. Instead, this arrangement configuration is given by the independent layer info SEI messages contained in each media stream. This information may be used for performing the append operations.

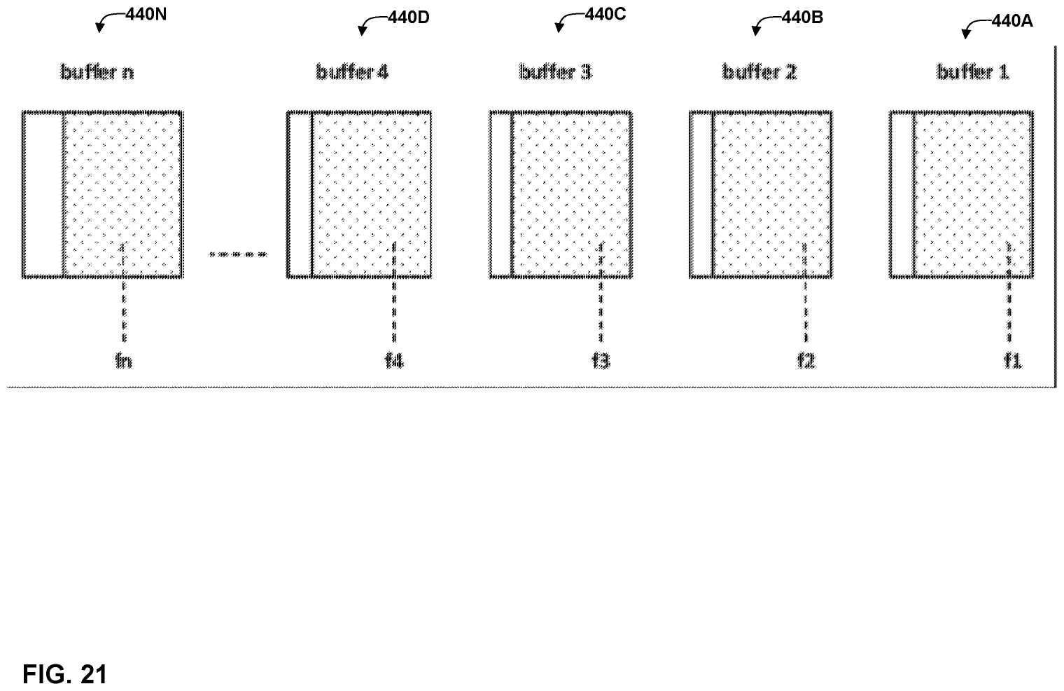

FIG. 21 is a conceptual diagram illustrating an example of connected components and buffer usage according to techniques of this disclosure. An OpenMAX IL client may call OMX_Init( ) as a first call into OpenMAX IL. OMX_Init( ) initializes the OMX core engine prior to any usage of it. Once done, the engine may be released by calling OMX_Deinit( ).

OMX defines a naming convention for the component names with the following format: OMX.<vendor_name>.<vendor_specified_convention>. Once the instance is no longer needed, the OMX_FreeHandle( ) is called to free all related resources.

The function can be called multiple times with the same component name to create multiple instances of the component.

OMX_GetHandle( ) is used to locate a requested component through its provided name. If the requested component is available, the OMX core engine will invoke the components methods to fill the component handle and setup the callbacks. The OpenMAX AL is the interface that will be used by the application to perform media playback and processing. However, the OpenMAX IL interface is the interface that provides direct access to video decoder components and their capabilities. Therefore, this disclosure describes the OpenMAX IL interface for the purpose of providing additional features, which may enable a flexible multi-video decoder platform and its interface for six degrees of freedom (6DoF) applications.

A Tunnel may be used to connect the input and output ports of two connected components. OMX_SetupTunnel( ) is used to establish a tunnel connecting an output port of a component to the input port of another component. When creating the tunnel, the components may negotiate a compatible input/output format for the connected ports. When no longer needed, the application calls the OMX_TeardownTunnel( ) to tear down the tunnel.

In the example of FIG. 21, component 424 includes an output port, component 426 includes an input port and an output port, and component 428 includes an input port. Buffer use 420 corresponds to the output ports of components 424 and 426, while buffer port 422 corresponds to the input ports of components 426 and 428.

The components communicate among each other and with the application through buffer exchange. For this purpose, OMX_AllocateBuffer( ), OMX_UseBuffer( ), OMX_FillThisBuffer( ), OMX_EmptyThisBuffer( ), and OMX_FreeBuffer( ) are defined. These function calls are non-blocking. A component asks a preceding component to fill an input buffer by calling the OMX_FillThisBuffer( ) method and asks a succeeding component to retrieve the content of an output port buffer by calling the OMX_EmptyThisBuffer( ) function. Only one buffer per tunnel may be used, and one of the two components acts a supplier of that buffer.

OMX_SetConfig( )is used to configure a component by the application. The application passes a structure that contains the configuration parameters to the component. The configuration parameters are published by each component and are component specific.

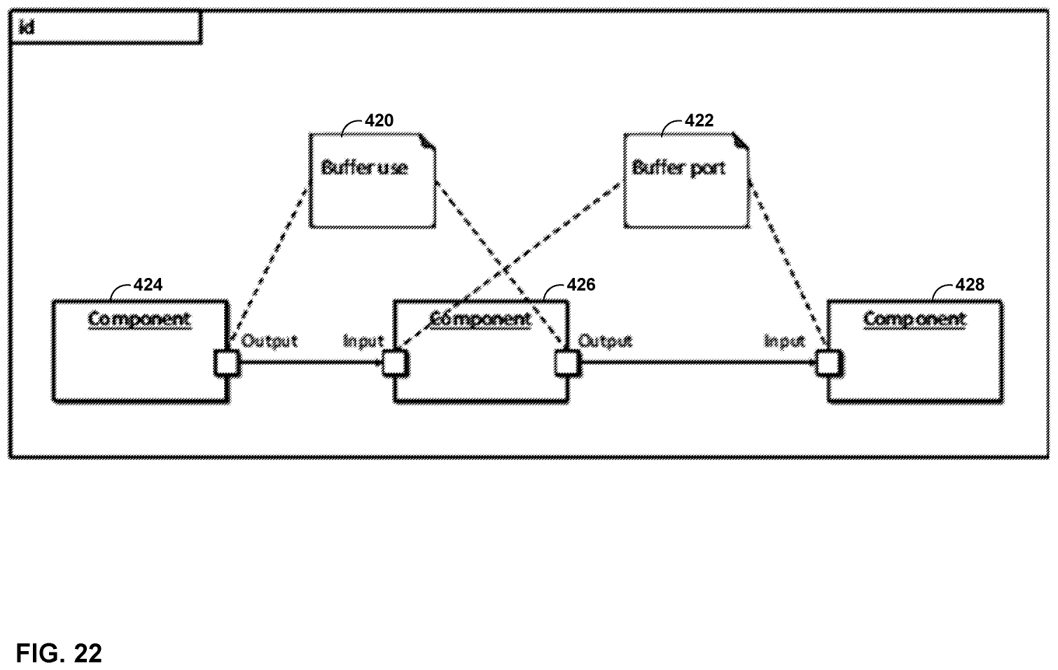

FIG. 22 is a conceptual diagram illustrating example port configurations for various buffers according to techniques of this disclosure. FIG. 22 depicts example buffers 440A-44N. The port configuration is used to define the format of the data to be transferred on a component port. The buffer header contains a reference to the buffer pBuffer, an offset inside that buffer nOffset, and the length of that buffer nFilledLen. Multiple buffers can be used to pass data, which allows for more flexibility in the communication between components, i.e., more than one frame can be exchanged at a time.

There is no requirement on frame alignment to buffer start. The application or preceding components provide frame alignment information as part of the buffer header using the OMX_BUFFERFLAG_ENDOFFRAME_flag. It is also possible to signal sub-frame boundaries to identify NAL unit boundaries using the OMX_BUFFERFLAG_ENDOFSUBFRAME.

A timestamp is also provided by the buffer header for every buffer. The nTimestamp corresponds to the presentation timestamp of the first media sample that starts at the current buffer. If multiple samples are included in the current buffer, the start timestamp of the following samples is inferred from the nTimestamp and the sample duration. That information can then be propagated through the pipeline and may be passed to the application through the output buffer.

The buffer header structure may be:

```
typedef struct OMX_BUFFERHEADERTYPE
{
  OMX_U32 nSize;
  OMX_VERSIONTYPE nVersion;
  OMX_U8* pBuffer;
  OMX_U32 nAllocLen;
  OMX_U32 nFilledLen;
  OMX_U32 nOffset;
  OMX_PTR pAppPrivate;
  OMX_PTR pPlatformPrivate;
  OMX_PTR pInputPortPrivate;
  OMX_PTR pOutputPortPrivate;
  OMX_HANDLETYPE hMarkTargetComponent;
  OMX_PTR pMarkData;
  OMX_U32 nTickCount;
  OMX_TICKS nTimeStamp;
  OMX_U32 nFlags;
  OMX_U32 nOutputPortIndex;
  OMX_U32 nInputPortIndex;
} OMX_BUFFERHEADERTYPE;
```

The list of buffer flags may be:

| | |
|---|---|
| #define OMX_BUFFERFLAG_EOS | 0x00000001 |
| #define OMX_BUFFERFLAG_STARTTIME | 0x00000002 |
| #define OMX_BUFFERFLAG_DECODEONLY | 0x00000004 |
| #define OMX_BUFFERFLAG_DATACORRUPT | 0x00000008 |
| #define OMX_BUFFERFLAG_ENDOFFRAME | 0x00000010 |
| #define OMX_BUFFERFLAG_SYNCFRAME | 0x00000020 |
| #define OMX_BUFFERFLAG_EXTRADATA | 0x00000040 |
| #define OMX_BUFFERFLAG_CODECONFIG | 0x00000080 |
| #define OMX_BUFFERFLAG_TIMESTAMPINVALID | 0x00000100 |
| #define OMX_BUFFERFLAG_READONLY | 0x00000200 |
| #define OMX_BUFFERFLAG_ENDOFSUBFRAME | 0x00000400 |

OpenMAX IL introduces the possibility to use an EGL Image as an output buffer. An EGL Image is designed for sharing data between rendering-based EGL interfaces, such as OpenGL and the OpenMAX components. It is up to the component to implement OMX_UseEGLImage( ) to link the output to an EGL Image instead of a traditional buffer.

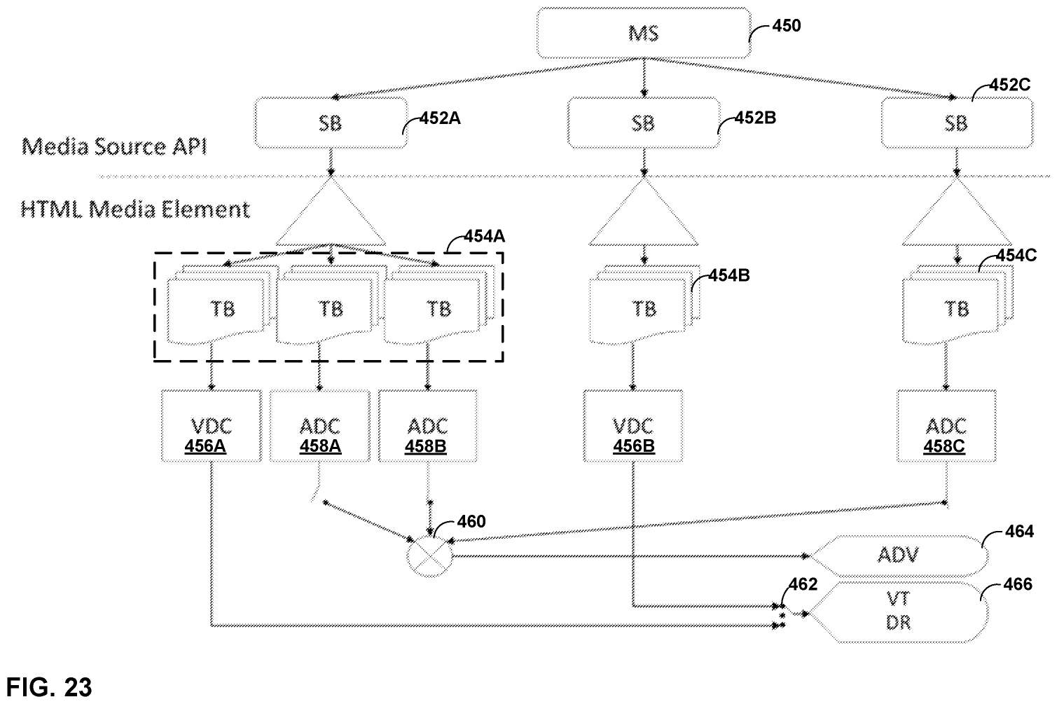

FIG. 23 is a conceptual diagram illustrating an example of media source extension (MSE) media interfaces according to techniques of this disclosure. MSE is a set of extensions to the media source attributes of HTML5 video and audio elements. It enables flexible control of media streams through JavaScript code using the definition of MediaSource objects. A MediaSource object may have one or more SourceBuffer objects. Applications append media segments to the SourceBuffer objects. A SourceBuffer may have multiple tracks, which are decoded and played separately. FIG. 23 depicts an example setup of MSE including the interface between the MSE API and the HTML5 media element.

The example of FIG. 23 shows media source (MS) 450 including source buffers (SBs) 452A, 452B, and 452C. Source buffer 452A provides data to track buffers (TBs) 454A, which include both video and audio data. The video data is decoded by video decoder (VDC) 456A, while the two sets of audio data are decoded by audio decoders (ADCs) 458A and 458B. Source buffer 452B provides data to track buffer 454B, which includes video data decoded by video decoder 456B. Source buffer 452C provides data to track buffer 454C, which includes audio data decoded by audio decoder 458C. Audio data selector 460 selects and/or combines the decoded audio data to output audio data to audio device (ADV) 464, while video data selector 462 selects and/or combines the decoded video data to send video tags and decoded video data to display region 466.

Table 10 represents a possible mapping of the VDI functions onto the MSE API:

TABLE 10

| VDI Functionality | MSE Mapping |
|---|---|
| queryCurrentAggregate | MediaSource.queryCurrentAggregate |
| Capabilities( ) | Capabilities( ) ^{a} |
| getInstance( ) with grouping | MediaSource.addSourceBuffer( ) ^{b} |
| setConfig( ) | VideoTrack.setConfig( ) ^{c} |
| CONFIG_OUTPUT_BUFFER | |
| getParameter( ) and | VideoTrack and AudioTrack, |
| setParameter( ) | getParameter( ) and setParameter( ) ^{d} |

NOTE
Rationale and description are provided below.
^{a} A new method of the MediaSource object is used to query the current decode capabilities.
^{b} Tracks of the same type, e.g. VideoTracks, that belong to the same SourceBuffer are considered alternatives and only one is decoded and presented. When creating a new SourceBuffer, a group identifier for each track type may be provided. This grouping applies all currently instantiated MediaSource objects. This allows for grouping of multiple decoder instances that belong to multiple HTML5 media elements.
^{c} New method of the HTML5 VideoTrack object.
^{d} New methods of HTML5 VideoTrack and AudioTrack objects.

In addition, an extension to the HTML5 video element may be used to allow outputting data into buffers, e.g., WebGL buffers that are created through gl.createBuffer( ) functions. An extension to the input byte stream format may also be used to add support for raw media data, e.g., AVC raw media streams.

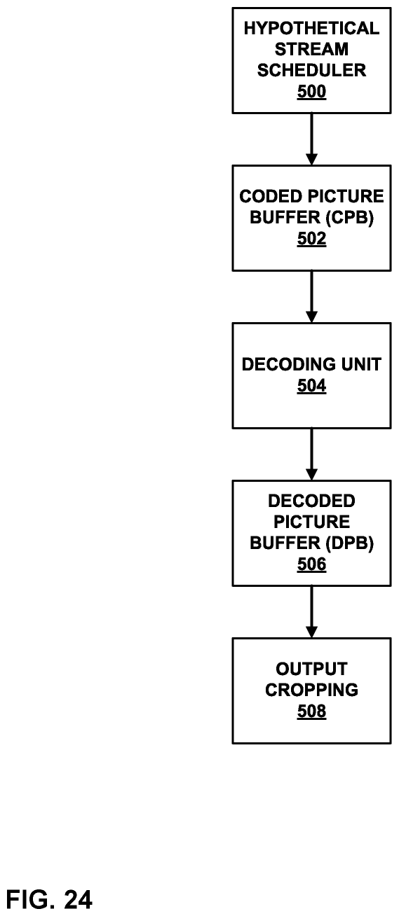

FIG. 24 is a block diagram illustrating an example video decoding hypothetical reference decoder. In this example, the hypothetical reference decoder includes hypothetical stream scheduler 500, coded picture buffer (CPB) 502, decoding unit 504, decoded picture buffer (DPB) 506, and output cropping unit 508. A video decoding interface may conform to the example video decoding hypothetical reference decoder of FIG. 24. That is, a video decoding interface may include components similar to those shown in and described with respective to FIG. 24.

A video decoding interface may have the following parameters that describe characteristics (e.g., decoding capabilities) of the video decoding interface: a profile (e.g., sub-sampling and bit depth support, such as 4:2:0 color format and 10 bits for bit depth); aggregate level capabilities (e.g., megabits per second (MB/s) bitrate, such as “level 6.1”); a number of instances (e.g., 16 instances); and codecs supported (e.g., ITU-T H.264/Advanced Video Coding (AVC) and ITU-T H.265/High Efficiency Video Coding (HEVC)). Therefore, the content may include data signaling maximum required decoding/rendering capabilities for each bitstream (e.g., using profile/level/tier signaling). A group of coded bitstreams may be associated with a group having common maximum capabilities.

The video decoding interface may perform various functions. Such functions may include decoding of conforming video bitstreams and storage of encoded video data in a common coded picture buffer for a group of decoders. Associated access units across bitstreams provided at the same time to the coded picture buffer may be provided synchronously to a group of decoders. Supplemental enhancement information (SEI) messages associated with the access units may be provided synchronously at the decoder output.

An access unit may be referred to as “access unit n,” where n is a number that uniquely identifies the access unit. N may be incremented by 1 for each subsequent access unit in decoding order. Each decoding unit may be referred to as “decoding unit m,” where m is a number that uniquely identifies the decoding unit. The first decoding unit in the ordinal first access unit (access unit 0) may be referred to as “decoding unit 0.” The value of m may be incremented by 1 for each subsequent decoding unit in decoding order. “Picture n” may refer to the coded picture or the decoded picture of access unit n. Timing information related to a specific decoding unit may arrive prior to the CPB removal time of that decoding unit.

The hypothetical reference decoder (HRD) of FIG. 24 may include initialization parameters. For example, HRD_parameters( ) and sub_layer_hrd_parameters( ) may include coded picture buffer (CPB) size and decoded picture buffer (DPB) size, which may be signaled in an SEI message, sequence parameter set (SPS), picture parameter set (PPS), or inferred from other values. For example, CPB size may be inferred as CpbVclFactor*MaxCPB. Additionally, a bitrate value may represent maximum input bitrate (on access unit (AU) and decoding unit (DU) levels). Furthermore, a sub-picture HRD flag may indicate whether an operation mode is AU mode or DU mode.

In the example of FIG. 24, the hypothetical reference decoder may be initialized at decoding unit 0, with both CPB 502 and DPB 506 being set to empty. Hypothetical stream scheduler 500 may generally schedule retrieval of video data (e.g., access units) from various bitstreams and store the retrieved video data to CPB 502. That is, hypothetical stream scheduler 500 may deliver data associated with decoding units that flow into CPB 502 according to a specific arrival schedule. The various bitstreams may be a group of bitstreams having aggregate maximum decoding capabilities that can be satisfied by the corresponding decoder device. Decoding unit 504 may retrieve decoding units from CPB 502 corresponding to the retrieved video data and decode the decoding units (e.g., blocks, slices, frames/pictures, etc.) In the case of a hypothetical reference decoder, it is assumed that decoding unit 504 decodes data associated with each decoding unit instantaneously at the CPB removal time of the corresponding decoding unit. Decoding unit 504 may store the decoded data to DPB 506. Output cropping unit 508 may retrieve decoded pictures from DPB 506 and crop the pictures prior to output to a display device. A decoded picture may be removed from DPB 506 when the picture becomes no longer needed for inter prediction reference and no longer needed for output.

CPB 502 may operate as follows. Initially, decoding unit m may arrive at an initial arrival time. In some examples, the initial arrival time for decoding unit m (i.e., initArrivalTime[m]) may be set equal to an access unit final arrival time of a previous access unit (m−1) for CBR mode. Otherwise, for non-CBR mode, the initial arrival time for decoding unit m may be set equal to the maximum of the arrival time of the previous access unit (AuFinalArrivalTime[m−1]) and the initial arrival time of the earliest decoding unit of the current access unit (initArrivalEarliestTime[m]).

The hypothetical reference decoder may calculate initArrivalEarliestTime[m] as being equal to Au/DuNominalRemovalTime[m]−(InitCpbRemovalDelay[SchedSelIdx]+InitCpbRemovalDelayOffset[SchedSelIdx])/90,000. The hypothetical reference decoder may calculate AuFinalArrivalTime [m−1] as being equal to initArrivalTime[m]+sizeInBits[m]/BitRate[SchedSelIdx]. The hypothetical reference decoder may calculate a time for decoding unit removal according to AuNominalRemovalTime[0]=InitCpbRemovalDelay[SchedSelIdx]/90,000.

DPB 506 may contain various picture storage buffers. Each of the picture storage buffers may contain one or more decoded pictures, which may be marked as “used for reference” or held for future output. The hypothetical reference decoder may calculate DpbOutputTime[n], a time at which to remove picture n from DPB 506, as being equal to AuCpbRemovalTime[n]+ClockSubTick*picSptDpbOutputDuDelay. Decoding unit 504 may store a current decoded picture in DPB 506 in an empty picture storage buffer. Fullness of DPB 506 may then be incremented by one. When TwoVersionsOfCurrDecPicFlag is equal to 0 and pps_currpic_ref_enabled_flag is equal to 1, the corresponding picture may be marked as “used for long-term reference.” After all slices of the current picture have been decoded, the picture may be marked as “used for short-term reference.”

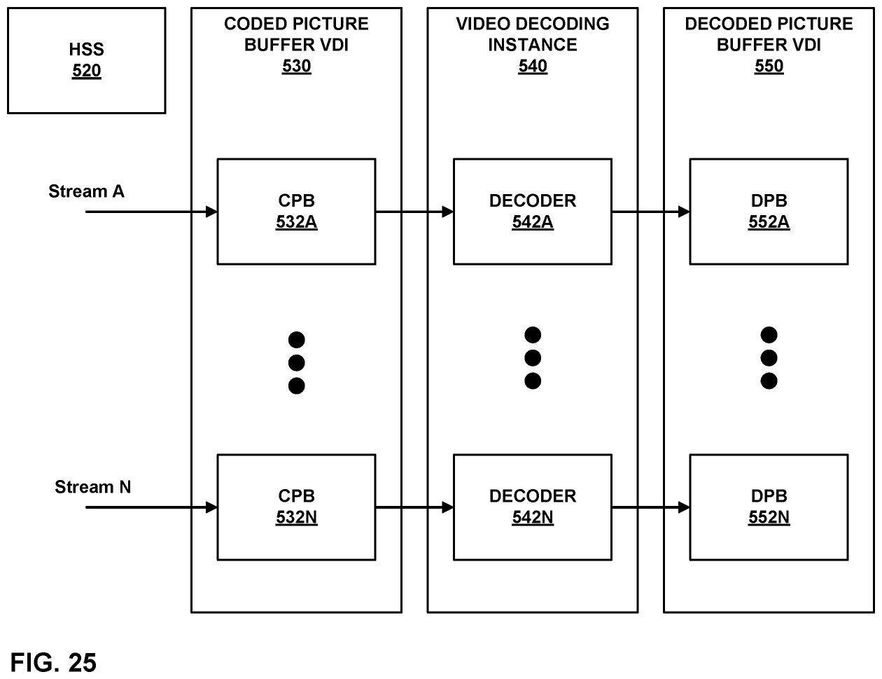

The techniques of this disclosure may be applied in situations where there are N video streams that are to be decoded concurrently. Each of the N video streams may have corresponding profile/tier/level requirements and HRD requirements as specified in parameters included in the bitstream. A video decoding system per the techniques of this disclosure may correspond to one of the following models, shown in FIGS. 25-27 respectively below.

FIG. 25 is a block diagram illustrating an example model of a video decoding system that may perform techniques of this disclosure to decode multiple video streams in parallel using multiple video decoding instances. In this example, coded picture buffers (CPBs) and decoded picture buffers (DPBs) run independently for each of N decoders.

In particular, the example of FIG. 25 depicts CPB video decoding interface (VDI) 530, video decoding instances 540, and decoded picture buffer VDI 550. To decode N streams in parallel, N decoding instances may be instantiated. Thus, video decoding instances 540 include decoders 542A-542N (decoders 542). Each of decoders 542 is associated with a respective one of CPBs 532A-543N (CPBs 532) and a respective one of DPBs 552A-552N (DPBs 552).

Data associated with decoding units that flow into one of CPBs 532 of each stream according to a specified arrival schedule may be delivered by a common hypothetical stream scheduler (HSS) 520 that schedules the N bitstreams for decoding by respective decoders 542. For each access unit, all data associated with the access unit may be removed and decoded by the corresponding one of decoders 542 at the CPB removal time of the access unit. The one of decoders 542 may then place the decoded picture in the corresponding one of DPBs 552 for reference during the decoding process of the stream, as well as for output and cropping. A decoded picture may be removed from one of DPBs 552 after the picture has been output when the picture is no longer needed for inter-prediction reference.

At any point in time, each of the individual bitstreams may conform to the signaled profile/tier/level and HRD parameters of the individual stream. At any point in time, the sum of the CPB size may conform to profile/tier/level signaling. At any point in time, the aggregate decoder processing speed (samples per second) may conform to profile/tier/level signaling. And at any point in time, the sum of the DPB size may conform to profile/tier/level signaling. Common HRD parameters for initial delay may also be specified.

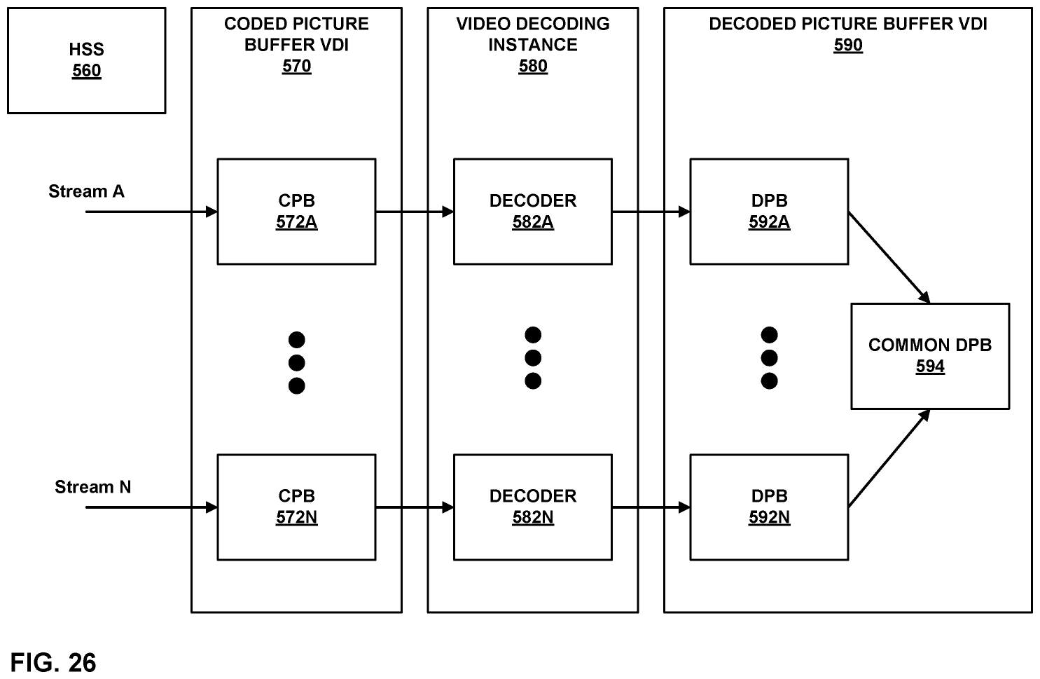

FIG. 26 is a block diagram illustrating another example model of a video decoding system that may perform techniques of this disclosure to decode multiple video streams in parallel using multiple video decoding instances. In this example, CPBs run independently for each of N decoders, but a combined DPB is used to ensure that output of the N decoders can be provided with proper timing in a synchronous manner for output or other subsequent processing.

In particular, the example of FIG. 26 depicts CPB VDI 570, video decoding instances 580, and DPB VDI 590. To decode N streams in parallel, N decoding instances may be instantiated. Thus, video decoding instances 580 include decoders 582A-582N (decoders 582). Each of decoders 582 is associated with a respective one of CPBs 572A-572N (CPBs 572). In this example, DPB VDI 590 includes DPBs 592A-592N, as well as common DPB 594 that is shared among all decoding instances.

Data associated with decoding units that flow into one of CPBs 572 of each stream according to a specified arrival schedule may be delivered by a common hypothetical stream scheduler (HSS) 560 that schedules the N bitstreams for decoding by respective decoders 582. For each access unit, all data associated with the access unit may be removed and decoded by the corresponding one of decoders 582 at the CPB removal time of the access unit. The one of decoders 582 may then place the decoded picture in the corresponding one of DPBs 592 for reference during the decoding process of the stream, as well as for output and cropping. A decoded picture may be removed from one of DPBs 552 after the picture has been output when the picture is no longer needed for inter-prediction reference and when the decoded picture has an output time that is largest of all decoded pictures remaining for the group of decoders 582.

At any point in time, each of the individual bitstreams may conform to the signaled profile/tier/level and HRD parameters of the individual stream. At any point in time, the sum of the CPB size may conform to profile/tier/level signaling. At any point in time, the aggregate decoder processing speed (samples per second) may conform to profile/tier/level signaling. At any point in time, the sum of the DPB size may conform to profile/tier/level signaling. And at any point in time, the common DPB size may conform to profile/tier/level signaling. Common HRD parameters for initial delay may also be specified.

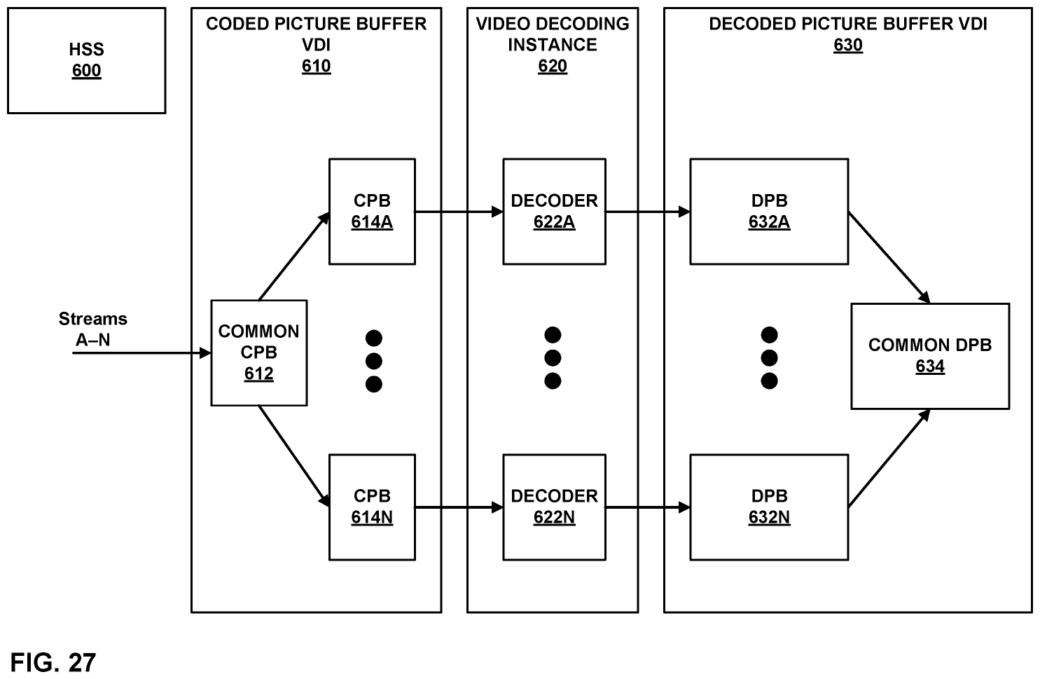

FIG. 27 is a block diagram illustrating another example model of a video decoding system that may perform techniques of this disclosure to decode multiple video streams in parallel using multiple video decoding instances. In this example, there are both a common CPB and a common DPB for each of the N decoders.

In particular, the example of FIG. 27 depicts CPB VDI 610, video decoding instances 620, and DPB VDI 630. To decode N streams in parallel, N decoding instances may be instantiated. Thus, video decoding instances 620 include decoders 622A-622N (decoders 622). Each of decoders 622 is associated with a respective one of CPBs 614A-614N (CPBs 614). Additionally, in this example, CPB VDI 610 includes common CPB 612. In this example, DPB VDI 630 includes DPBs 632A-632N, as well as common DPB 634 that is shared among all decoding instances.

Data associated with decoding units that flow into one of CPBs 572 of each stream according to a specified arrival schedule may be delivered by a common hypothetical stream scheduler (HSS) 600 that schedules the N bitstreams for decoding by respective decoders 622. The addition of each decoding unit may be done according to a common HSS. For each access unit, all data associated with the access unit may be removed and decoded by the corresponding one of decoders 622 at the CPB removal time of the access unit. The one of decoders 622 may then place the decoded picture in the corresponding one of DPBs 632 for reference during the decoding process of the stream, as well as for output and cropping. A decoded picture may be removed from one of DPBs 632 after the picture has been output when the picture is no longer needed for inter-prediction reference and when the decoded picture has an output time that is largest of all decoded pictures remaining for the group of decoders 622.

At any point in time, each of the individual bitstreams may conform to the signaled profile/tier/level and HRD parameters of the individual stream. At any point in time, the sum of the CPB size may conform to profile/tier/level signaling. At any point in time, the aggregate decoder processing speed (samples per second) may conform to profile/tier/level signaling. At any point in time, the sum of the DPB size may conform to profile/tier/level signaling. At any point in time, the common DPB size may conform to common profile/tier/level signaling. And at any point in time, the common CPB may conform to common profile/tier/level signaling. Common HRD parameters for initial delay may also be specified.

Bitstreams may be generated in various ways. In one example, bitstreams may be jointly generated. For example, the bitstreams may be encoded with VDI-based decoding in mind. Overall HRD parameters may be defined, and overall a set of encoders may be controlled to ensure that the common HRD parameters are maintained.

In another example, bitstreams may be individually generated. That is, streams may be encoded independently. Each stream may be annotated with individual profile/tier/level and HRD parameters. Additional information may be provided for each bitstream to support joint decoding (e.g., decoded pictures). A common HRD operation may be derived by the decoder/client device.

In some examples, a stream scheduler may select streams according to annotation parameters.

In some examples, each bitstream may include encoding metadata such that HRD parameters can be derived on the fly at the decoder side/client device.

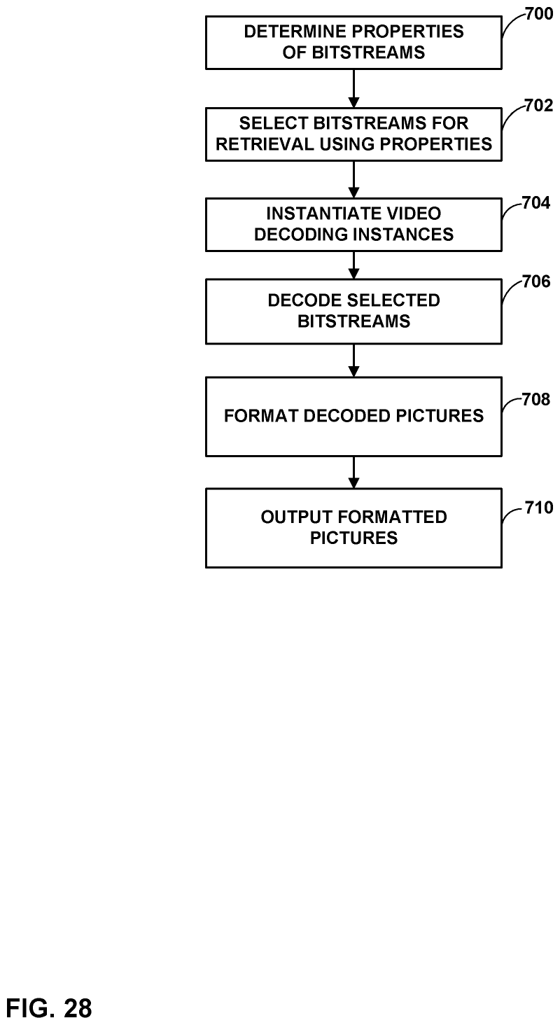

FIG. 28 is a flowchart illustrating an example method of decoding video data according to the techniques of this disclosure. The method of FIG. 28 may be performed by any of the various decoding devices of this disclosure. For purposes of example and explanation, the method of FIG. 28 is described with respect to video decoding engine 200 of FIG. 3. However, other devices may perform this or similar techniques, such as video decoder 48 of FIG. 1, hardware video decoding engine 212 of FIGS. 4-6, video decoder engine 340 of FIG. 15, video decoder engine 350 of FIG. 16, video decoder engine 370 of FIG. 17, video decoder engine 412 of FIG. 20, decoding unit 504 of FIG. 24, video decoding instances 540 of FIG. 25, video decoding instances 580 of FIG. 26, or video decoding instances 620 of FIG. 27.

Initially, a stream scheduling unit (e.g., RTP receiving unit 52 of FIG. 1) may initially determine properties of a variety of video bitstreams (700). The properties may be, for example, profile/tier/level information, HRD parameters, or the like. The bitstreams may be bitstreams that are intended to be combined for parallel retrieval, decoding, and presentation, or may be separate bitstreams that are subsequently combined. RTP receiving unit 52 may select several of the bitstreams for retrieval using the properties (702). For example, RTP receiving unit 52 may determine decoding capabilities of, e.g., video decoding engine 200 of FIG. 3.

Video decoding engine 200 may then instantiate a number of video decoder instances 214 (704), e.g., an equal number of video decoder instances to the number of video bitstreams to be retrieved. Video decoder instances 214 may then decode the selected bitstreams (706). Output formatting unit 208 may further format the decoded pictures (708), e.g., as shown in and described with respect to any of FIGS. 8-20. Video decoding engine 200 may then output the formatted pictures (710).

In this manner, the method of FIG. 28 represents an example of a method of decoding media data, including: instantiating a first number of video decoder instances to be executed by video decoding hardware implemented in circuitry; determining properties of a plurality of video media streams, the properties indicating that each of the plurality of video media streams is available for streaming selection; selecting a second number of input video media streams from the plurality of video media streams according to the determined properties of the second number of input video media streams; decoding, by the video decoder instances, the second number of input video media streams to form the second number of decoded video media streams; and outputting data of the second number of decoded video media streams.

Various examples of the techniques of this disclosure are summarized in the following clauses:

Clause 1: A method of decoding media data, the method comprising: instantiating a first number of video decoder instances to be executed by video decoding hardware; decoding, by the video decoder instances, a second number of input video media streams to form one or more decoded video media streams; and outputting data of the one or more decoded video media streams.

Clause 2: The method of clause 1, further comprising receiving configuration data indicating the first number.

Clause 3: The method of clause 2, wherein receiving the configuration data comprises receiving the configuration data from a media player application.

Clause 4: The method of clause 2, wherein receiving the configuration data comprises receiving one or more supplemental enhancement information (SEI) messages with the input video media streams.

Clause 5: The method of any of clauses 1-4, further comprising: receiving a third number of received video media streams; and formatting the received video media streams to form the second number of input video media streams.

Clause 6: The method of clause 5, wherein formatting the received video media stream comprises inserting a first video object from a first received video media stream to a side of a second video object from a second video media stream.

Clause 7: The method of any of clauses 5 and 6, wherein formatting the received video media streams comprises inserting a first video object from a first received video media stream above or below a second video object from a second video media stream.

Clause 8: The method of any of clauses 5-7, wherein formatting the received video media streams comprises appending a first video object from a first received video media stream to a second video object from the first received video media stream.

Clause 9: The method of any of clauses 5-8, wherein formatting the received video media streams comprises stacking a first video object from a first received video media stream on top of a second video object from the first received video media stream.

Clause 10: The method of any of clauses 1-9, wherein outputting the data of the one or more decoded video media streams comprises appending a first decoded picture of a first video media stream above, below, to the left of, or to the right of a second decoded picture of a second video media stream.

Clause 11: The method of any of clauses 5-10, further comprising receiving configuration data from a media application indicating how the input video media streams are to be combined to form a single output video media stream.

Clause 12: The method of any of clauses 5-10, further comprising receiving information of a supplemental enhancement information (SEI) message indicating how the input video media streams are to be combined to form a single output video media stream.

Clause 13: A device for decoding media data, the device comprising one or more means for performing the method of any of clauses 1-12.

Clause 14: The device of clause 13, wherein the one or more means comprise one or more processors and a memory configured to store media data.

Clause 15: The device of clause 13, wherein the device comprises at least one of: an integrated circuit; a microprocessor; and a wireless communication device.

Clause 16: A device for retrieving media data, the device comprising: means for instantiating a first number of video decoder instances to be executed by video decoding hardware; means for executing the video decoder instances to decode a second number of input video media streams to form one or more decoded video media streams; and means for outputting data of the one or more decoded video media streams.

Clause 17: A method of decoding media data, the method comprising: instantiating a first number of video decoder instances to be executed by video decoding hardware implemented in circuitry; determining properties of a plurality of video media streams, the properties indicating that each of the plurality of video media streams is available for streaming selection; selecting a second number of input video media streams from the plurality of video media streams according to the determined properties of the second number of input video media streams; decoding, by the video decoder instances, the second number of input video media streams to form the second number of decoded video media streams; and outputting data of the second number of decoded video media streams.

Clause 18: The method of clause 17, further comprising receiving configuration data indicating the first number.

Clause 19: The method of clause 18, wherein receiving the configuration data comprises receiving the configuration data from a media player application.

Clause 20: The method of clause 18, wherein receiving the configuration data comprises receiving one or more supplemental enhancement information (SEI) messages with the input video media streams.

Clause 21: The method of clause 17, further comprising: receiving a third number of received video media streams; and formatting the received video media streams to form the second number of input video media streams.

Clause 22: The method of clause 21, wherein formatting the received video media stream comprises inserting a first video object from a first received video media stream to a side of a second video object from a second video media stream.

Clause 23: The method of clause 21, wherein formatting the received video media streams comprises inserting a first video object from a first received video media stream above or below a second video object from a second video media stream.

Clause 24: The method of clause 21, wherein formatting the received video media streams comprises appending a first video object from a first received video media stream to a second video object from the first received video media stream.

Clause 25: The method of clause 21, wherein formatting the received video media streams comprises stacking a first video object from a first received video media stream on top of a second video object from the first received video media stream.

Clause 26: The method of clause 21, further comprising receiving configuration data from a media application indicating how the input video media streams are to be combined to form a single output video media stream.

Clause 27: The method of clause 21, further comprising receiving information of a supplemental enhancement information (SEI) message indicating how the input video media streams are to be combined to form a single output video media stream.

Clause 28: The method of clause 17, wherein outputting the data of the one or more decoded video media streams comprises appending a first decoded picture of a first video media stream above, below, to the left of, or to the right of a second decoded picture of a second video media stream.

Clause 29: The method of clause 17, wherein the properties of the plurality of the video media streams comprise profile, tier, and level requirements and hypothetical reference decoder (HRD) requirements.

Clause 30: The method of clause 17, wherein each of the first number of video decoder instances includes a respective coded picture buffer (CPB) and a respective decoded picture buffer (DPB).

Clause 31: The method of clause 17, wherein each of the first number of video decoder instances includes a respective coded picture buffer (CPB), and wherein the first number of video decoder instances shares a common decoded picture buffer (DPB).

Clause 32: The method of clause 17, wherein the first number of video decoder instances includes a shared common coded picture buffer (CPB) and a shared common decoded picture buffer (DPB).

Clause 33: The method of clause 17, wherein selecting the second number of input video media streams comprises: determining decoding capabilities of the first number of video decoder instances; determining rendering capabilities for rendering the second number of decoded video media streams; and selecting the second number of the input video media streams that can be decoded according to the decoding capabilities and rendered according to the rendering capabilities.

Clause 34: A device for decoding media data, the device comprising: a memory configured to store video data; and a processing system comprising one or more processors implemented in circuitry, the processing system being configured to: instantiate a first number of video decoder instances to be executed by the processing system; determine properties of a plurality of video media streams, the properties indicating that each of the plurality of video media streams is available for streaming selection; select a second number of input video media streams from the plurality of video media streams according to the determined properties of the second number of input video media streams; execute the video decoder instances to decode the second number of input video media streams to form the second number of decoded video media streams; and output data of the second number of decoded video media stream.

Clause 35: The device of clause 34, wherein the memory comprises a common decoded picture buffer (DPB) to store decoded pictures for each of the video decoder instances.

Clause 36: The device of clause 34, wherein the memory comprises a common coded picture buffer (CPB) to store encoded pictures for each of the video decoder instances.

Clause 37: A method of decoding media data, the method comprising: instantiating a first number of video decoder instances to be executed by video decoding hardware implemented in circuitry; determining properties of a plurality of video media streams, the properties indicating that each of the plurality of video media streams is available for streaming selection; selecting a second number of input video media streams from the plurality of video media streams according to the determined properties of the second number of input video media streams; decoding, by the video decoder instances, the second number of input video media streams to form the second number of decoded video media streams; and outputting data of the second number of decoded video media streams.

Clause 38: The method of clause 37, further comprising receiving configuration data indicating the first number.

Clause 39: The method of clause 38, wherein receiving the configuration data comprises receiving the configuration data from a media player application.

Clause 40: The method of any of clauses 38 and 39, wherein receiving the configuration data comprises receiving one or more supplemental enhancement information (SEI) messages with the input video media streams.

Clause 41: The method of any of clauses 37-40, further comprising: receiving a third number of received video media streams; and formatting the received video media streams to form the second number of input video media streams.

Clause 42: The method of clause 41, wherein formatting the received video media stream comprises inserting a first video object from a first received video media stream to a side of a second video object from a second video media stream.

Clause 43: The method of any of clauses 41 and 42, wherein formatting the received video media streams comprises inserting a first video object from a first received video media stream above or below a second video object from a second video media stream.

Clause 44: The method of any of clauses 41-43, wherein formatting the received video media streams comprises appending a first video object from a first received video media stream to a second video object from the first received video media stream.

Clause 45: The method of any of clauses 41-44, wherein formatting the received video media streams comprises stacking a first video object from a first received video media stream on top of a second video object from the first received video media stream.

Clause 46: The method of any of clauses 41-45, further comprising receiving configuration data from a media application indicating how the input video media streams are to be combined to form a single output video media stream.

Clause 47: The method of any of clauses 41-46, further comprising receiving information of a supplemental enhancement information (SEI) message indicating how the input video media streams are to be combined to form a single output video media stream.

Clause 48: The method of any of clauses 37-47, wherein outputting the data of the one or more decoded video media streams comprises appending a first decoded picture of a first video media stream above, below, to the left of, or to the right of a second decoded picture of a second video media stream.

Clause 49: The method of any of clauses 37-48, wherein the properties of the plurality of the video media streams comprise profile, tier, and level requirements and hypothetical reference decoder (HRD) requirements.

Clause 50: The method of any of clauses 37-49, wherein each of the first number of video decoder instances includes a respective coded picture buffer (CPB) and a respective decoded picture buffer (DPB).

Clause 51: The method of any of clauses 37-50, wherein each of the first number of video decoder instances includes a respective coded picture buffer (CPB), and wherein the first number of video decoder instances shares a common decoded picture buffer (DPB).

Clause 52: The method of any of clauses 37-51, wherein the first number of video decoder instances includes a shared common coded picture buffer (CPB) and a shared common decoded picture buffer (DPB).

Clause 53: The method of any of clauses 37-52, wherein selecting the second number of input video media streams comprises: determining decoding capabilities of the first number of video decoder instances; determining rendering capabilities for rendering the second number of decoded video media streams; and selecting the second number of the input video media streams that can be decoded according to the decoding capabilities and rendered according to the rendering capabilities.

Clause 54: A device for decoding media data, the device comprising: a memory configured to store video data; and a processing system comprising one or more processors implemented in circuitry, the processing system being configured to: instantiate a first number of video decoder instances to be executed by the processing system; determine properties of a plurality of video media streams, the properties indicating that each of the plurality of video media streams is available for streaming selection; select a second number of input video media streams from the plurality of video media streams according to the determined properties of the second number of input video media streams; execute the video decoder instances to decode the second number of input video media streams to form the second number of decoded video media streams; and output data of the second number of decoded video media stream.

Clause 55: The device of clause 54, wherein the memory comprises a common decoded picture buffer (DPB) to store decoded pictures for each of the video decoder instances.

Clause 56: The device of any of clauses 54 and 55, wherein the memory comprises a common coded picture buffer (CPB) to store encoded pictures for each of the video decoder instances.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding media data, the method comprising:
instantiating a first number of video decoder instances to be executed by video decoding hardware implemented in circuitry;
determining properties of a plurality of video media streams, the properties indicating that each of the plurality of video media streams is available for streaming selection;
selecting a second number of input video media streams from the plurality of video media streams according to the determined properties of the second number of input video media streams;
decoding, by the video decoder instances, the second number of input video media streams to form the second number of decoded video media streams; and
outputting data of the second number of decoded video media streams.

2. The method of claim 1, further comprising receiving configuration data indicating the first number.

3. The method of claim 2, wherein receiving the configuration data comprises receiving the configuration data from a media player application.

4. The method of claim 2, wherein receiving the configuration data comprises receiving one or more supplemental enhancement information (SEI) messages with the input video media streams.

5. The method of claim 1, further comprising:
receiving a third number of received video media streams; and
formatting the received video media streams to form the second number of input video media streams.

6. The method of claim 5, wherein formatting the received video media stream comprises inserting a first video object from a first received video media stream to a side of a second video object from a second video media stream.

7. The method of claim 5, wherein formatting the received video media streams comprises inserting a first video object from a first received video media stream above or below a second video object from a second video media stream.

8. The method of claim 5, wherein formatting the received video media streams comprises appending a first video object from a first received video media stream to a second video object from the first received video media stream.

9. The method of claim 5, wherein formatting the received video media streams comprises stacking a first video object from a first received video media stream on top of a second video object from the first received video media stream.

10. The method of claim 5, further comprising receiving configuration data from a media application indicating how the input video media streams are to be combined to form a single output video media stream.

11. The method of claim 5, further comprising receiving information of a supplemental enhancement information (SEI) message indicating how the input video media streams are to be combined to form a single output video media stream.

12. The method of claim 1, wherein outputting the data of the one or more decoded video media streams comprises appending a first decoded picture of a first video media stream above, below, to the left of, or to the right of a second decoded picture of a second video media stream.

13. The method of claim 1, wherein the properties of the plurality of the video media streams comprise profile, tier, and level requirements and hypothetical reference decoder (HRD) requirements.

14. The method of claim 1, wherein each of the first number of video decoder instances includes a respective coded picture buffer (CPB) and a respective decoded picture buffer (DPB).

15. The method of claim 1, wherein each of the first number of video decoder instances includes a respective coded picture buffer (CPB), and wherein the first number of video decoder instances shares a common decoded picture buffer (DPB).

16. The method of claim 1, wherein the first number of video decoder instances includes a shared common coded picture buffer (CPB) and a shared common decoded picture buffer (DPB).

17. The method of claim 1, wherein selecting the second number of input video media streams comprises:
determining decoding capabilities of the first number of video decoder instances;
determining rendering capabilities for rendering the second number of decoded video media streams; and
selecting the second number of the input video media streams that can be decoded according to the decoding capabilities and rendered according to the rendering capabilities.

18. A device for decoding media data, the device comprising:
a memory configured to store video data; and
a processing system comprising one or more processors implemented in circuitry, the processing system being configured to:
instantiate a first number of video decoder instances to be executed by the processing system;
determine properties of a plurality of video media streams, the properties indicating that each of the plurality of video media streams is available for streaming selection;
select a second number of input video media streams from the plurality of video media streams according to the determined properties of the second number of input video media streams;
execute the video decoder instances to decode the second number of input video media streams to form the second number of decoded video media streams; and
output data of the second number of decoded video media stream.

19. The device of claim 18, wherein the memory comprises a common decoded picture buffer (DPB) to store decoded pictures for each of the video decoder instances.

20. The device of claim 18, wherein the memory comprises a common coded picture buffer (CPB) to store encoded pictures for each of the video decoder instances.
